(19) United States
(12) Patent Application Publication
(10) Pub. No.: US 2010/0312679 A1
(43) Pub. Date: Dec. 9, 2010

(54) System and Method for Analyzing Bank Payment Patterns

(76) Inventor: Martin Frederick Lebouitz, Tampa, FL (US)

Correspondence Address: JAMES F MCLAUGHLIN, 11 Ashwood Lane, Brookfield, CT, 06804, US

(21) Appl. No.: 12/624,388

(22) Filed: Nov. 23, 2009

Related U.S. Application Data
(63) Continuation-in-part of application No. 11/512,011, filed on Aug. 29, 2006, now Pat. No. 7,624,070.

(51) Int. Cl. G06Q 40/00; G06Q 90/00

(52) U.S. Cl. 705/35; 705/500

(57) ABSTRACT

A automated system and method is provided for banks and financial institutions to filter and capture data streams of payment related information, and more particularly SWIFT messages, providing information on payment routing, corporate banking intelligence, wallet share, liquidity retention targeting, Eurozone revenue streams, cross-currency streams, networking opportunities, new business targets, threshold monitoring, and reciprocity monitoring whereby reports, advisory messages, or alerts are generated and transmitted to a system user so as to provide strategic information to increase one's potential for capturing further market share.

### CROSS REFERENCES TO RELATED APPLICATIONS

This application is a Continuation In Part patent application and claims a priority benefit to US Non-Provisional Application Ser. No. 11/512,011 entitled “Open Payments Target Marketing System”, examined by Examiner Lindsay MaGuire in Art Unit 3692, and filed in the United States Patent and Trademark Office on Aug. 29, 2006 by a common Inventor to this instant application, Martin Frederick Lebouitz.

### STATEMENT REGARDING FEDERALLY SPONSORED RESEARCH

Not Applicable

### REFERENCE TO APPENDIX

Not Applicable

### BACKGROUND OF THE INVENTION

1. Field of the Invention

The present invention relates generally to a system and method by which banks implement an automated process to identify and analyze payment related information, and, more particularly, to such a system and method requiring an identification of incoming payments correspondent banks route through competitors; the capture of information, including the correspondent bank the payment originated from, the competitor the payment was sent through, the account party (correspondent bank's customer), the payment beneficiary (customer), and payment ID information (reference numbers, date and amount) associated with such payments; the generation of an advisory message to the correspondent bank that payment can be made directly from their account (book transfer) and the generation of a report to correspondent identifying indirectly routed payments for the month.

2. Description of the Prior Art

Electronic and online banking has long been known in the prior art, from the transfer of moneys between banks and other institutions to the ability of an individual to monitor and control his or her accounts via a secure Internet website.

It should be appreciated that in today's world of electronic commerce, a bank's payments business forms an extensive “network” that extends well beyond its customers. Incoming and outdoing payment flows touch a bank's customers, it's customers doing business with other customers, correspondent banks directly and on behalf of its customers and their customers, its customers' transactions to their customers with accounts at other banks, and even its customers' transactions from their customers with accounts at other banks. The present invention recognizes that each of these payment flows gives rise to other opportunities to capture additional payment volumes through the data mining of existing payments information.

There exists a significant opportunity for banks to increase the volume of high-value payments they receive, thereby generating additional revenues by creatively using information they already have available. The present invention is directed to a process whereby a user can leverage its correspondent bank network and corporate customer base to: (1) capture high-value payments that are now going to its competitors; (2) extend its business to its customers' customers; (3) size its correspondent banks' payments wallet; (4) allocate reciprocity based on correspondent banks wallet share; and (5) develop an “early warning system” to detect threshold shifts in payments business.

As shall be appreciated, the prior art fails to specifically address either the problem or the solution arrived upon by applicant.

### SUMMARY OF THE INVENTION

It is a primary object of the present invention to provide a system and method by which banks implement an automated process to identify and analyze payment related information and act upon said information on a real-time or near real-time basis.

It is another object of the present invention to provide such a system and method to identify potential new correspondent bank customers who have a significant volume of payment activity between that bank's customer and the user's customers. The pattern of activity will identify the top prospects based on volume of payments as well as trend in payment volumes and will also identify specific customer patterns that are driving existing volumes and trends in volume.

It is another object of the present invention to provide such a system and method that provides the user with an in-depth understanding of the user's patterns of business and the opportunities they give rise to.

It is still another object of the present invention to provide such a system and method that allows a user to capture high-value payments that are now going to the user's competitors.

It is but another object of the present invention to provide such a system and method that allows a user to extend the user's business to the user's customers' customers.

It is yet still another object of the present invention to provide such a system and method that allows a user to size the user's correspondent banks' payments wallet and allocate reciprocity based on correspondent bank wallet share.

It is another object of the present invention to provide such a system and method that allows a user to develop an “early warning system” to detect threshold shifts in payments business.

It is yet another object of the present invention to provide such a system and method that can significantly increase a user's high-value payments business by allowing the user to use the information the user currently has at the user's bank to work smarter.

It is but another object of the present invention to provide such a system and method that can easily be customized to meet the user's needs.

It is still another object of the present invention to provide such a system and method that is based on a readily available and existing framework, such as HP's Open Payments solution framework using technology such as HP Real Time Financial Services (RTFS) and HP OpenView BPI.

It is another object of the present invention to provide such a system and method that estimates wallet size of correspondent bank's payments relative shares by competitors versus the user's.

It is yet a further object of the present invention to provide such a system and method for identifying customer relationships at risk of significantly declining volumes or lost relationship.

It is yet another object of the present invention to provide such a system and method that identifies how much business a user is giving it's correspondent bank in relation to the trend in business they are giving the user versus their competitors.

It is a further object of the present invention to provide such a system and method that identifies how a correspondent bank, who has a relation with a user, is instead sending a payment to the user's customer through an intermediary bank who is the user's competitor.

It is also an object of the present invention to provide such a system and method for estimating wallet size of customer payments relative shares by competitors versus a user.

It is another object of the present invention to provide such a system and method that identifies customers who are transferring large amounts of funds to investment vehicles outside the bank and leaving a low overnight balance for investment opportunities to retain funds in the bank overnight.

It is a further object of the present invention to provide such a system and method for identifying potential new customers who have a significant volume of payment activity between a user's customers within the Eurozone but not the home country of the bank, which pattern will identify the top prospects based on volume of payments and to show top Customer to Beneficiary pairs.

It is also an object of the present invention to provide such a system and method that identifies potential new customers or existing customers who have a significant volume of payment activity in one currency but not in another.

It is another object of the present invention to provide such a system and method that identifies potential new customers who have a significant volume of payment activity from existing customers so as to identify the top prospects based on volume of payments.

It is still another object of the present invention to provide such a system and method that identifies patterns of conduct from a customer which may be suspicious when looking at inbound on-us transfers, outbound on-us transfers, inbound not on-us transfer and outbound not on-us transfers.

It is yet another object of the present invention to provide such a system and method that allows a user to enlarge its business footprint in the euro-zone.

It is another object of the present invention to provide such a system and method that allows conversion of corporate prospects to a user's customers to bring broad relationship benefits in addition to payments—including investment management, corporate finance, commercial lending, and investment banking

It is but another object of the present invention to provide such a system and method that will identify and prioritize opportunities and provide the actionable information to develop successful offers to convert candidate companies to becoming a user's customers.

To the accomplishments of the foregoing objects and advantages, the present invention, in brief summary comprises a system and method by which banks implement an automated process to identify and analyze payment related information, and, more particularly, to such a system and method requiring an identification of incoming payments correspondent banks route through competitors; the capture of information, including the correspondent bank the payment originated from, the competitor the payment was sent through, the account party (correspondent bank's customer), the payment beneficiary (customer), and payment ID information (reference numbers, date and amount) associated with such payments; the generation of an advisory message to the correspondent bank that payment can be made directly from their account (book transfer) and the generation of a report to correspondent banks identifying indirectly routed payments for the month.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing the information path used in analyzing skipped payments pattern;

FIG. 2 is a flow diagram showing the outbound information path of corporate intelligence;

FIG. 3 is a flow diagram showing the inbound information path of corporate intelligence;

FIG. 4 is a flow diagram showing the information path used in the wallet share analyzer;

FIG. 5 is a flow diagram showing the information path used in liquidity retention targeting at the beginning of the day;

FIG. 6 is a flow diagram showing the information path used in liquidity retention targeting at the end of the day;

FIG. 7 is a flow diagram showing the information path used for inbound opportunity identification and targeting in the Eurozone;

FIG. 8 is a flow diagram showing the information path used for outbound opportunity identification and targeting in the Eurozone;

FIG. 9 is a flow diagram showing the information path used for inbound cross-currency identification and targeting;

FIG. 10 is a flow diagram showing the information path used for outbound cross-currency identification and targeting;

FIG. 11 is a flow diagram showing the information path used for network opportunity identification and targeting;

FIG. 12 is a flow diagram showing the information path used for inbound new business qualification and acquisition;

FIG. 13 is a flow diagram showing the information path used for outbound new business qualification and acquisition;

FIG. 14 is a flow diagram showing the information path used in the wallet sizing and competitive position analyzer;

FIG. 15 is a flow diagram showing the information path used in the threshold driven business at risk warning analyzer;

FIG. 16 is a flow diagram showing the information path used in the threshold driven business at risk warning analyzer;

FIG. 17 is a flow diagram showing the information path used in analyzing indirect payments;

FIG. CB.1 is a table describing benefits and actions of skipped payments with automated alert;

FIG. CB.2 is a table describing benefits and actions of corporate intelligence;

FIG. CB.3 is a table describing benefits and actions of competitive wallet share analyzer;

FIG. CB.3A is a table describing the results of a wallet share analysis;

FIG. CB.4 is a table describing benefits and actions of end of day liquidity retention targeting system;

FIG. CB.4A is a table describing the results of an end of day liquidity retention analysis;

FIG. CB.5 is a table describing benefits and actions of euro-zone inbound opportunity identification and targeting;

FIG. CB.5A is a table describing a Eurozone Inbound opportunity and targeting analysis;

FIG. CB.6 is a table describing benefits and actions of euro-zone outbound opportunity identification and targeting;

FIG. CB.6A is a table describing a Eurozone Outbound opportunity and targeting analysis;

FIG. CB.7 is a table describing benefits and actions of cross currency identification and targeting;

FIG. CB.8 is a table describing benefits and actions of network opportunity identification and targeting;

FIG. FI.1 is a table describing benefits and actions of new business qualification and acquisition;

FIG. FI.1-1 is a flow chart identifying sending institutions who are not customers but would be good candidates;

FIG. FI.1A is a table describing a new business qualification and acquisition analysis;

FIG. FI.2 is a table describing benefits and actions of wallet sizing and competitive position analyzer;

FIG. FI.2-1 is a flow chart to determine the wallet size of our correspondent and what percentage of their business we are getting:

FIG. FI.2A is a table describing a wallet sizing and competitive position analysis;

FIG. FI.3 is a table describing benefits and actions of threshold driven business at risk warning;

FIG. FI.3-1 is a flow chart to identify decreased volume to our bank from a specific sending institution:

FIG. FI.3A is a table describing a threshold-driven business at risk analysis;

FIG. FI.4 is a table describing benefits and actions of a reciprocity analyzer;

FIG. FI.4-1 is a flow chart to ensure our level of business stays reciprocal with our correspondents level of business with us;

FIG. FI.4A is a table describing a reciprocity analysis; and

FIG. FI.5 is a table describing benefits and actions of indirect payment routing.

### DETAILED DESCRIPTION OF THE INVENTION

Much of the analysis and method or system in this invention depends upon information contained in electronic messages that flow around the world on a daily basis between banks and financial institutions. Most banks and financial institutions use a well-known electronic messaging architecture called ‘SWIFT’.

SWIFT is the Society for Worldwide Interbank Financial Telecommunication, a member-owned cooperative through which the financial world conducts its business operations with speed, certainty and confidence. Over 8,300 banking organizations, securities institutions and corporate customers in more than 208 countries trust us every day to exchange millions of standardized financial messages.

SWIFT enables its customers to automate and standardize financial transactions, thereby lowering costs, reducing operational risk and eliminating inefficiencies from their operations. By using SWIFT customers can also create new business opportunities and revenue streams.

SWIFT is solely a carrier of messages. It does not hold funds nor does it manage accounts on behalf of customers, nor does it store financial information on an on-going basis. As a data carrier, SWIFT transports messages between two financial institutions.

In 2007, the SWIFT Board of Directors approved the implementation of a distributed architecture for SWIFT's messaging services. The distributed architecture partitions messaging into two zones, the European messaging zone and the Trans-Atlantic messaging zone, with pairs of Operating Centers that store the traffic for each zone. The implementation of the messaging zones was to take place by the end of 2009.

Countries in the European Economic Area, Switzerland and other territories and dependencies of the European Union or associated with EU countries, were assigned to, and must remain in, the European zone. The United States and its territories were assigned to, and must remain in, the Trans-Atlantic zone. The default allocation for all other countries was to the Trans-Atlantic zone.

Much of the work of this invention is based on analysis and processing of SWIFT messages. In general a SWIFT message is a collection of data in a structured format that a user or an application sends or receives. A message consists of blocks of data that contain information about addressing, optional features, control information for processing and delivery, security information, and the actual payload or message text. Messages are typically used to exchange individual transactions or short reports.

In this invention one particular message that is collected and analyzed is SWIFT Message Type 103, also known as ‘Swift MT 103 ’. The structure of the MT 103 is shown below. Applicant makes reference throughout this specification to various Swift Tags by identifying them in parentheses such as (20) is a reference to the field “Sender's Reference” and (59a) is a reference to the field “Beneficiary Customer”.

SWIFT MESSAGE TYPE 103 Basic Format Table

| Status | Tag | Field Name |
|---|---|---|
| M | 20 | Sender's Reference |
| O | 13C | Time Indication |
| M | 23B | Bank Operation Code |
| O | 23E | Instruction Code |
| O | 26T | Transaction Type Code |
| M | 32A | Value Date/Currency/Interbank Settled Amount |
| O | 33B | Currency/Instructed Amount |
| O | 36 | Exchange Rate |
| M | 50a | Ordering Customer |
| O | 51A | Sending Institution |
| O | 52a | Ordering Institution |
| O | 53a | Sender's Correspondent |
| O | 54a | Receiver's Correspondent |
| O | 55a | Third Reimbursement Institution |
| O | 56a | Intermediary Institution |
| O | 57a | Account With Institution |
| M | 59a | Beneficiary Customer |
| O | 70 | Remittance Information |
| M | 71A | Details of Charges |
| O | 71F | Sender's Charges |
| O | 71G | Receiver's Charges |
| O | 72 | Sender to Receiver Info |
| O | 77B | Regulatory Reporting |
| O | 77T | Envelope Contents |

M = Mandatory O = Optional

BIC is a code that is used in automated processing. This code unambiguously identifies a financial institution, or non-financial institution. The ISO 9362 standard specifies the elements and the structure of a BIC. A BIC consists of either eight (BIC8) or eleven (BIC11) contiguous characters. These characters comprise either the first three, or all four, of the following components: institution code, country coud, location code, and branch code. The International Organization for Standardization has designated SWIFT as the BIC registration authority.

Alliance is the SWIFT brand name for the range of connectivity products that customers use to connect to SWIFT services. The Bank File is a BIC Directory Download for Alliance users. This file can only be used to upload BIC data into your Correspondent Information File (CIF).

Single Euro Payments Area (SEPA) is the area in which all euro payments are considered domestic.

Consultative Committee International Telephone and Telegraph (CCITT) is the standards organization that represents the Post Telephone and Telephone (PTT) organisation, and creates international standards for telecommunications and data communications. The CCITT is now the International Telecommunications Union (ITU).

### Corporate Patterns

Listed below are eight methods for analyzing banking patterns of a pool of corporate customers. For example, lets assume ACME Gas Company has 500,000 customer accounts. ACME would employ this invention to analyze financial banking data. Specific patterns are detected with recommended actions to provide a benefit to ACME using these methods.

The SWIFT messages are captured and stored on a computer system and analyzed by a separate computer program that also generates reports and alerts which are configurable by a system operator. For example reports can be tailored by different parameters such as banks, routing codes, payment beneficiary or any of the Tag fields in the MT 103 structure. Alerts can be in the form of emails, administrator alerts, pager notification or other electronic methods of notification.

All of the steps below are implemented on a computer processing system which may be a stand alone system with a single dedicated display and printer, or it may be a networked system with computers anywhere in the world communicating by known methods. For example the data processing could take place in New York and the Action steps of displaying or printing the information could take place in Cairo Egypt. Even further to that point, the processing can be broken down into steps that take place on computer systems in disparate locations. The data collection may take place at a SWIFT operations center and then be forwarded to a customer for his own processing at his headquarters in Alanta, Ga., and the displaying and or reporting may take place in a Marketing Division located in London, UK.

In particular the “Action Steps” below include generating and storing a report in an electronic format (either proprietary or standardized) on or in an electronic medium such as a hard drive or magnetic tape, transmitting and displaying the information on a computer screen or screens, sending alerts and other information to portable and or handheld devices such as laptops and cell phones, printing the information on paper, and or transmitting the information in an electronic document format such as a spreadsheet via email or other transport protocol to an analyst, executive, officer, corporation or other interested party.

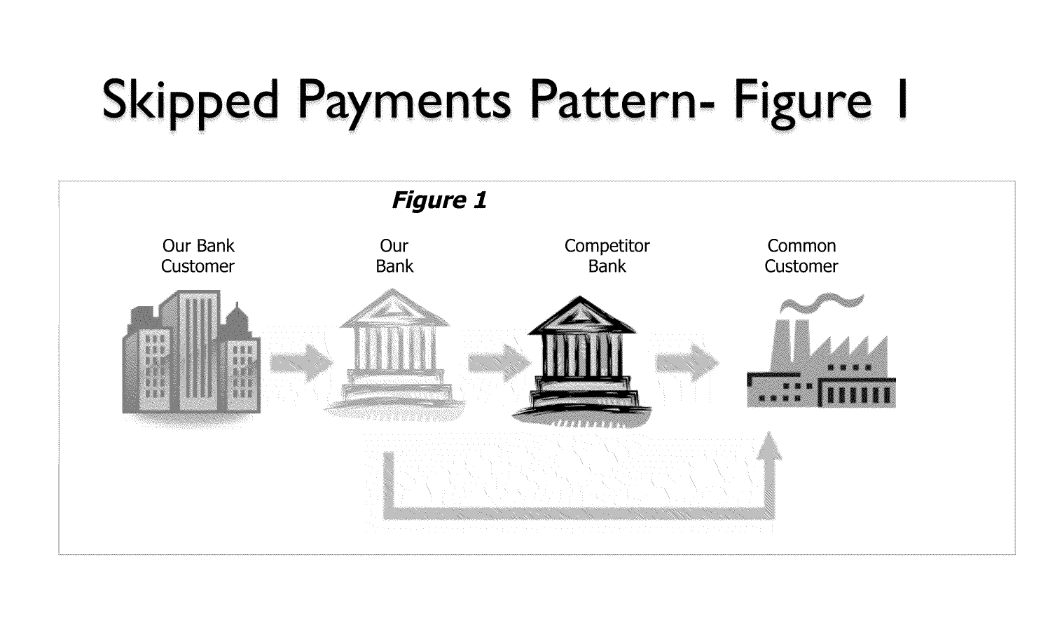

Now referring to FIG. 1 a skipped payment flow diagram is shown. Normally the payment is routed through the Competitor Bank, but our goal is to detect this unwanted flow and advise our customer so that we can reroute the payment and bypass the Competitor Bank.

CB.1 Corporate Banking: Skip Payments with Automated Alert

Refer to FIG. CB.1. Purpose: To identify payments being initiated by our customers paid from us posted to an account at a competitor bank for a beneficiary that is a customer of both the competitor and us. We would like to post this payment to the beneficiary's account at our bank.

Pattern Steps: (Based on SWIFT MT103 fields and the customer information file)
These are outbound payments from our customer that are not book transfers.
1. Is the beneficiary an existing customer?

Is the Beneficiary (59A) In CIF?

If Yes Go to Step 2.

If No. Go to next record.

2. Save record in Skipped_Payment file

### Fields

Ordering Party (50A)

Ordering party ID (50A)

Bank reference number (20)

Date (32A)

Time (32A)

Amount (32A)

Beneficiary name (59A)

Beneficiary address (59A)

Beneficiary country (5A)

Beneficiary bank name (57A)

Beneficiary bank BIC (57A)

### Analytic Steps:

Identify the number of payments that could be book transfers that are instead being routed outside the bank.

### Action Steps:

Take records in the Skipped_Payment file and sort by 50A (Ordering Party), then by Beneficiary Name (59A), then by Beneficiary Bank Name (57A).
Tally_Data_Date_{—}30_{—}90_{—}90_{—}180
Use 30_Day_Data_Count for each Ordering_Party and array by Beneficiary Name (59A) to form the Ordering-Party_By_Beneficary_{—}30_Day field.
Use 90_Day_Data_Count for each Ordering_Party and array by Beneficiary Name (59A) to form the Ordering-Party_By_Beneficary_{—}90_Day field.
Use 180_Day_Data_Count for each Ordering_Party and array by Beneficiary Name (59A) to form the Ordering-Party_By_Beneficary_{—}180_Day field.

As an additional or alternative display.
Use 30_Day_Data_Count for each Ordering_Party and array by Beneficiary Bank Name (57A) to form the Sending_Insitution_By_Intermediary_{—}30_Day field.
Use 90_Day_Data_Count for each Ordering_Party and array by Beneficiary Bank Name (57A) to form the Sending_Insitution_By_Intermediary_{—}90_Day field.
Use 180_Day_Data_Count for each Ordering_Party and array by Beneficiary Bank Name (57A) to form the Sending_Insitution_By_Intermediary_{—}180_Day field.

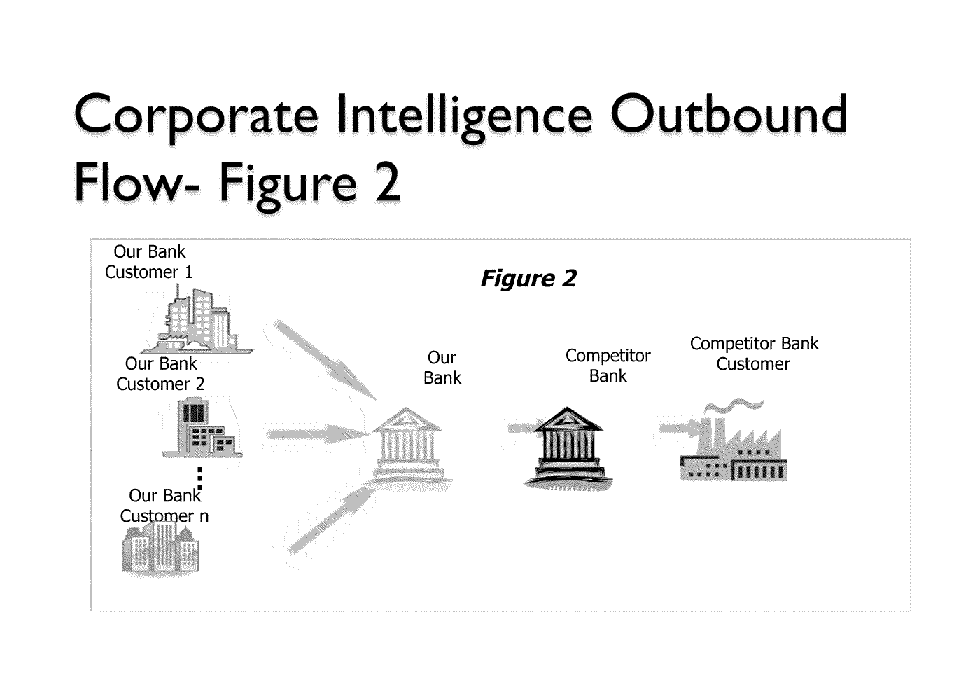

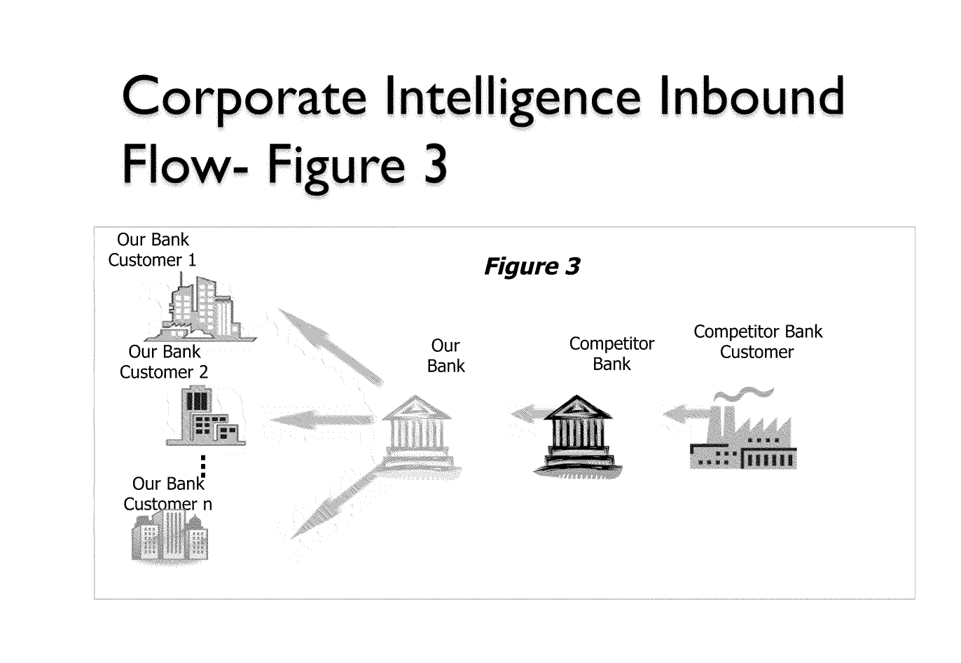

Now referring to FIGS. 2 & 3, corporate intelligence payment flows, both inbound and outbound is shown.

### CB.2 Corporate Banking: Corporate Intelligence

Refer to FIG. CB.2. Purpose: To identify the best new prospects based on payment volume with existing customers that could be book transfers—both inbound and outbound.

Pattern Steps: (Based on SWIFT MT103 fields and the customer information file)
For outbound payments that are not book transfers.
1. Is the beneficiary an existing customer?

Is the Beneficiary (59A) In CIF?

If No Go to Step 2.

If Yes. Go to next record.

2. Save record in Corp Intel Outbound file

### Fields

Ordering Party (50A)

Ordering party ID (50A)

Bank reference number (20)

Date (32A)

Time (32A)

Amount (32A)

Beneficiary name (59A)

Beneficiary address (59A)

Beneficiary country (59A)

Beneficiary bank name (57A)

Beneficiary bank BIC (57A)

For inbound payments that are not book transfers.
1. Is the Ordering Party an existing customer?

Is the Ordering Party (50A) In CIF?

If No Go to Step 2.

If Yes. Go to next record.

2. Save record in Corp_Intel_Inbound file

### Fields

Ordering Party (50A or 50K)

Ordering party ID (50A)

Ordering party address (50K)

Ordering party country (50A)

Sending Institution (51A)

Sending Institution BIC (51A)

Bank reference number (20)

Date (32A)

Time (32A)

Amount (32A)

Beneficiary name (59A)

### Analytical Steps:

Identify the number of payments that could be book transfers that are instead being routed outside the bank because the corporate is not a customer of the bank.

### Action Steps:

Take records in the Corp_Intel_Outbound file and sort by 59A (Beneficiary Name), then by Ordering Party (50A), then by Beneficiary Bank Name (57A).
Tally_Data_Date_{—}30_{—}90_{—}90_{—}180
Use 30_Day_Data_Count for each Beneficiary Name and array by Ordering Party (50A) to form the Beneficary_By_Ordering_Party_{—}30_Day field.
Use 90_Day_Data_Count for each Beneficiary Name and array by Ordering Party (50A) to form the Beneficary_By_Ordering_Party_{—}90_Day field.
Use 180_Day_Data_Count for each Beneficiary Name and array by Ordering Party (50A) to form the Beneficary_By_Ordering_Party_{—}180_Day field.

### Then

Take records in the Corp_Intel_Inbound file and sort by 50A (Ordering Party), then by Beneficiary Name (59A), then by Sending Institution (51A).
Tally_Data_Date_{—}30_{—}90_{—}90_{—}180
Use 30_Day_Data_Count for each Ordering_Party and array by Beneficiary Name (59A) to form the Ordering-Party_By_Beneficary_{—}30_Day field.
Use 90_Day_Data_Count for each Ordering_Party and array by Beneficiary Name (59A) to form the Ordering-Party_By_Beneficary_{—}90_Day field.
Use 180_Day_Data_Count for each Ordering_Party and array by Beneficiary Name (59A) to form the Ordering-Party_By_Beneficary_{—}180_Day field.

### Then

Merge Corporate_Intel_Outbound with Corp_Intel_Inbound to make Corp_Intel_Combined as follows:

| Corp_Intel_Inbound | Corp_Intel_Outbound | Corp_Intel_Combined |
|---|---|---|
| Ordering Party | Beneficiary Name | Prospect |
| (50A) | (59A) | |
| Sending Institution | Beneficiary Bank | Competitor |
| (51A) | (57A) | |
| Beneficiary Name | Ordering Party | Trading Partner |
| (59A) | (50A) | |

Take records in the Corp_Intel_Combined file and sort by Prospect, then by Trading Partner, then by Competitor.
Tally_Data_Date_{—}30_{—}90_{—}90_{—}180
Use 30_Day_Data_Count for each Prospect and array by Trading Partner to form the Prosect_By_Trading_Partner_{—}30_Day field.
Use 90_Day_Data_Count for each Prospect and array by Trading Partner to form the Prosect_By_Trading_Partner_{—}90_Day field.
Use 180_Day_Data_Count for each Prospect and array by Trading Partner to form the Prosect_By_Trading_Partner_{—}180_Day field.

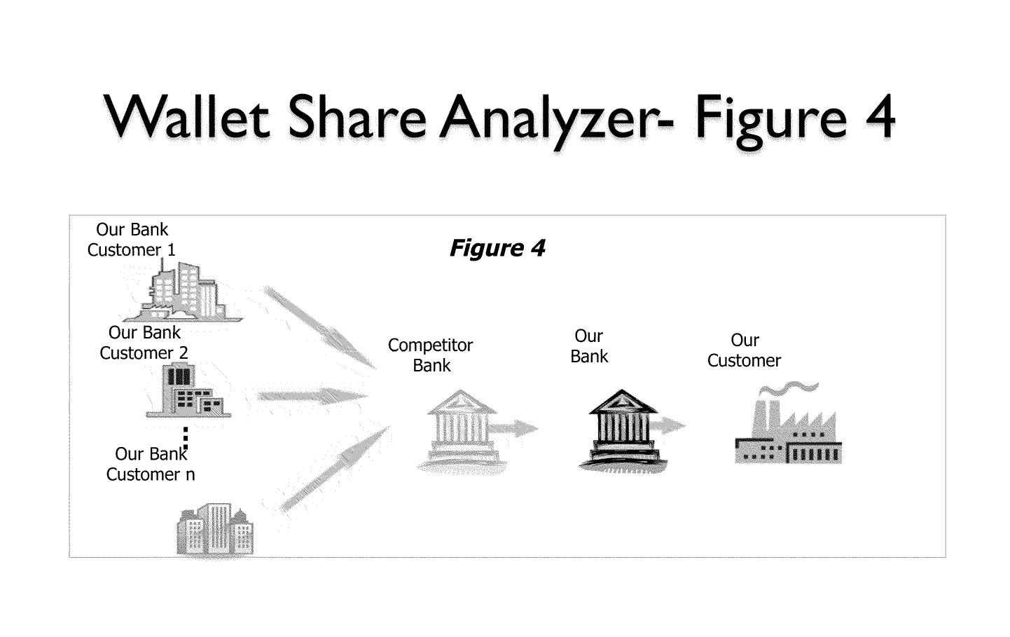

Now referring to FIG. 4 a wallet share analyzer flow diagram is shown.

### CB.3 Corporate Banking: Competitive Wallet Share Analyzer

Refer to FIG. CB.3. Purpose: To estimate wallet size of a customer payments relative shares by competitors versus ours.
Pattern Steps: (Based on SWIFT MT103 fields and the customer information file)
1. Is the Ordering Customer an existing customer?

Is field 50A=customer in our CIF?

If Yes Go to Step 2.

If No. Go to next record.

2. Is the Sending Institution one of our competitors (from speCIFied list)?

Is field 51A on list?

if no, move to next record

if yes include in Corporate Banking: Competitive Wallet Share Analyzer file

3. Save record to Database

Fields

32A—Value Date and Amount

50A—Ordering Customer

51A—Sending Institution

59A—Beneficiary Customer

### Analytical Steps:

Identify what percentage each of our customers is sending through other banks rather than through us. Refer to FIG. CB.3A.

### Action Steps:

Sort by descending order of SWIFT MT103s for debit (payments we initiate) and credit (payments we receive) based on field 50A
Sort by field 51A (Sending Correspondent)
If value date minus the current date is less than 30 days, count the number of payments
If value date minus the current date is less than 90 days, count the number of payments
If value date minus the current date is less than 180 days, count the number of payments
If value date minus the current date is less than 365 days, count the number of payments
Divide each 50A-51A pairing by our estimated market share to approximate total market volume

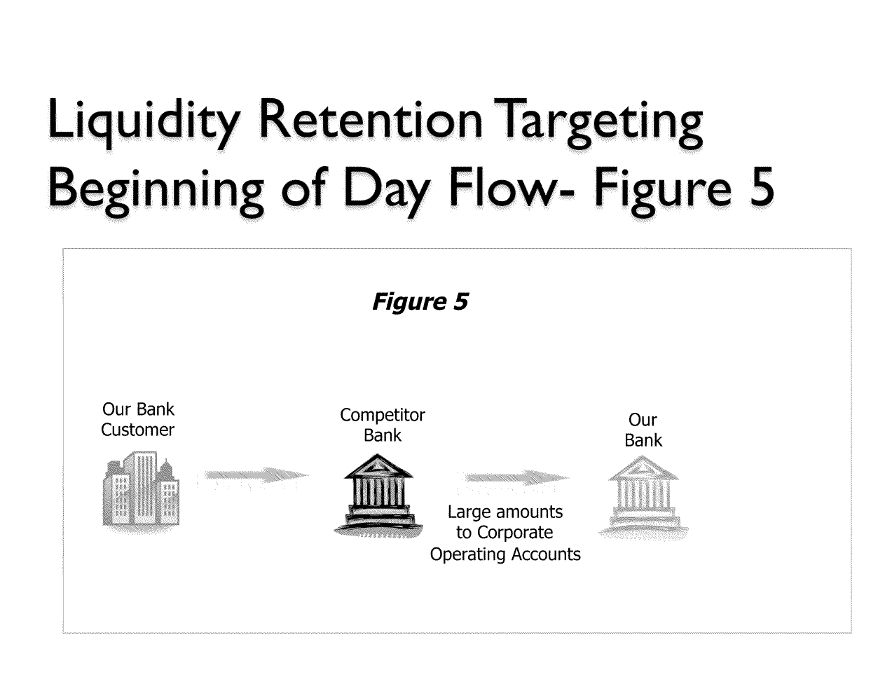

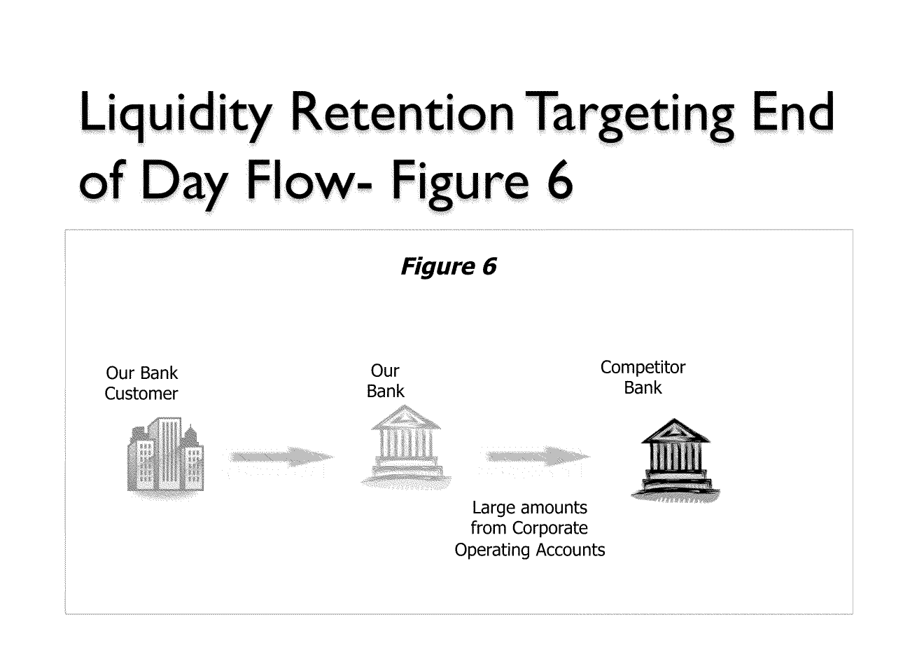

Now referring to FIGS. 5 & 6, a liquidity retention targeting flow diagrams are shown, one for the beginning of the day and one for the end of the day.

### CB.4 Corporate Banking: End of Day Liquidity Retention Targeting System

Refer to FIG. CB.4. Purpose: Identify customers who are transferring large amounts of funds to investment vehicles outside the bank and leaving a low overnight balance. We want to target these names for investment opportunities to retain funds in the bank overnight.

Pattern Steps: (Based on SWIFT MT103 fields and the customer information file)

### Define Significant_Transfer_Amount

1. Is the outbound payment greater than Significant_Transfer_Amount?

Is 32A>Significant_Transfer_Amount?

If Yes Go to Step 2.

If No. Go to next record.

### 2. Is it Near_End_Of_Day?

Is the time stamp after Near_End_Of_Day (field 13C)?

if no, move to next record

if yes include in End of Day Liquidity Retention file

3. Save record to Database

Fields

32A—Value Date and Amount

50A—Ordering Customer

59A—Beneficiary Customer

### Analytical Steps:

To identify large payments at end of day to top beneficiaries with a high percentage of transaction volume and $ value. Refer to FIG. CB.4A.

### Action Steps:

Aggregate Value for each 50A
Is end of day balance for 50A from DDA less than Retention_Target % of aggregated total?
   No—move to next customer
   Yes Flag records.
Add up number of customers and beni
Review information in DB for last 30 days
List by 50A where 59A is greater than 20% of number transaction and value (field 32A) is greater than 20% of total.
Rank order by 50A—59A pair with highest transaction value.

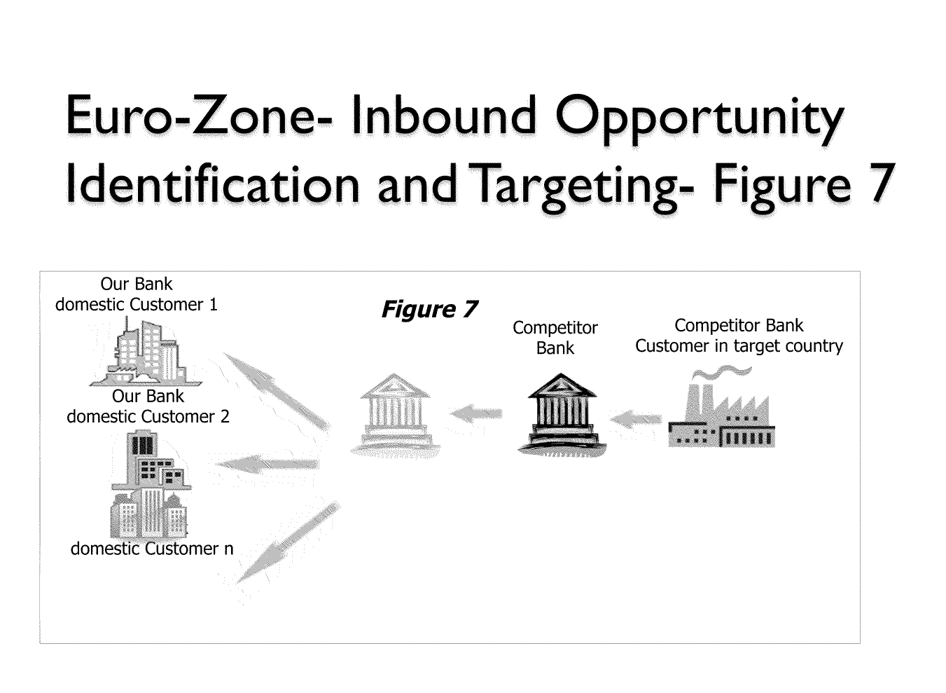

Now referring to FIG. 7 an inbound opportunity identification and targeting payment flow diagram is shown for the Eurozone.

CB.5 Corporate Banking: Eurozone Inbound Opportunity identification and Targeting

Refer to FIG. CB.5. Purpose: To identify potential new customers who have a significant volume of payment activity between to our customers within the Eurozone but not the home country of the bank. This pattern will identify the top prospects based on volume of payments. This can be extended to show top Customer to Beneficiary pairs.

Pattern Steps: (Based on SWIFT MT103 fields and the customer information file)
1. Is the Ordering Customer not an existing customer?

Is field 50A=not customer in our CIF?

If No then go to next record.

If yes. Go to step 2.

DEFINE HOME COUNTRY and EUROZONE

2. Is the country code outside the home country?

Is field 50A is not equal to home country?

If no, go to next record

If yes, go to step 3.

3. Is the country code a Euro Zone county?

Is field 50A=Eurozone country?

If yes to go step 4.

If no to go next record.

4. Save record to SEPA_Inbound file

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Ranking Order for Highest Potential New Customer based on Volume of Payments. Will aggregate the number of payments by Ordering Customer.

### Action Steps: Refer to FIG. CB.5A.

Sort by 50A
If value date minus the current date is less than 90 days count the number of payments (from field 32A)
Take number of payment by each 50A and divide by total number of payments in file to derive % of total by each Ordering Customer.
Show cumulative % of total for top 2, 3, 4, 5 etc.

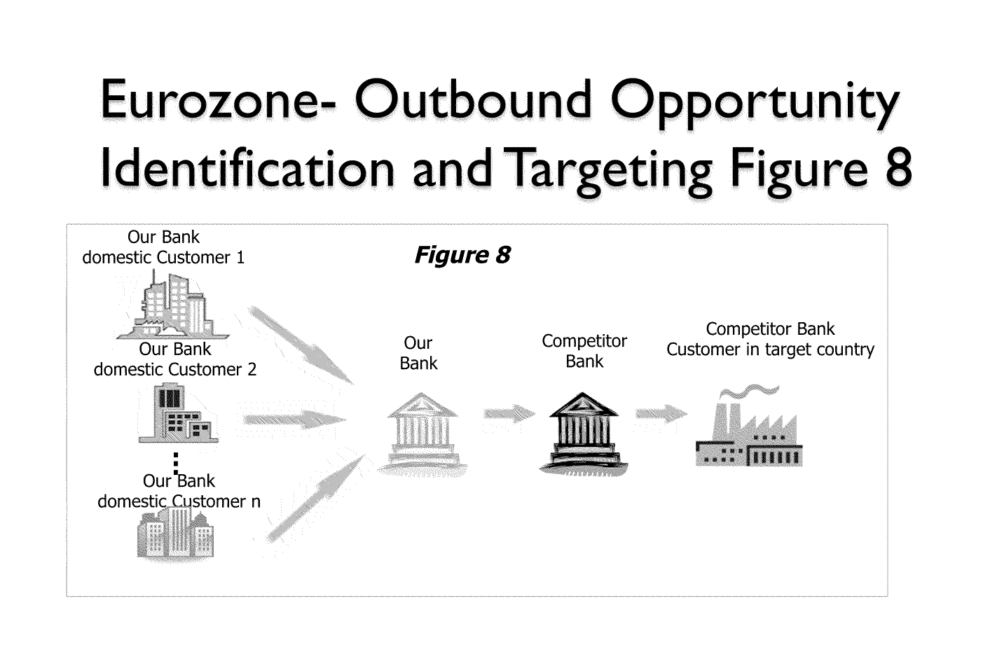

Now referring to FIG. 8 an outbound opportunity identification and targeting payment flow diagram is shown for the Eurozone.

CB.6 Corporate Banking: Euro-Zone Outbound Opportunity identification and Targeting

Refer to FIG. CB.6. Purpose: To identify potential new customers who have a significant volume of payment activity from our customers within the Euro-zone but not the home country of the bank. This pattern will identify the top prospects based on volume of payments. It can be extended to show top Customer to Beneficiary pairs.

Pattern Steps: (Based on SWIFT MT103 fields and the customer information file)
1. Is the Beneficiary Customer an existing customer?

Is field 59A=customer not in our CIF?

If Yes, Go to step 2.

If No. Then go to next record.

2. Is the country code the home country?

Is field 59A=to home country? (Home country defined as country where payment is being originated. Manual Input)

If yes, go to next record

If no, go to step 3.

3. Is the country code a Euro Zone county?

Is field 59A=Eurozone country? (Check against Euro_Zone_Country list)

If yes to go step 4.

If no to go next record.

4. Save record to Sepa_Outbound_Beneficiary Database

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Ranking Order for Highest Potential New Customer based on Volume of Payments. Will aggregate the number of payments by Beneficiary Customer.

### Action Steps: Refer to FIG. CB.6A

Sort Sepa_Outboud_Beneficiary by 59A
Tally. If value date (From field 32A) minus the current date is less than 90 days, count the number of payments and store in 90_Day_Data_Count field.
Order Sepa_Outbound_Beneficiary based on descending number in 90_Day_Data_Count.
Store first 100 records in Sepa_Outbound_Top_{—}100 database
On the Sepa_Outbound_Top_{—}100 database Sum the 90_Day_Data_Count field and put total in a Total_Top_{—}100 field
Take value in 90_Day_Data_Count field for each record and divide by Total_Top_{—}100 to derive % of total by each beneficiary and populate in %_Total field.
For each record add the %_Total to the Cumulative_%_Total of the record above and populate it in the Cumulative_%_Total field.

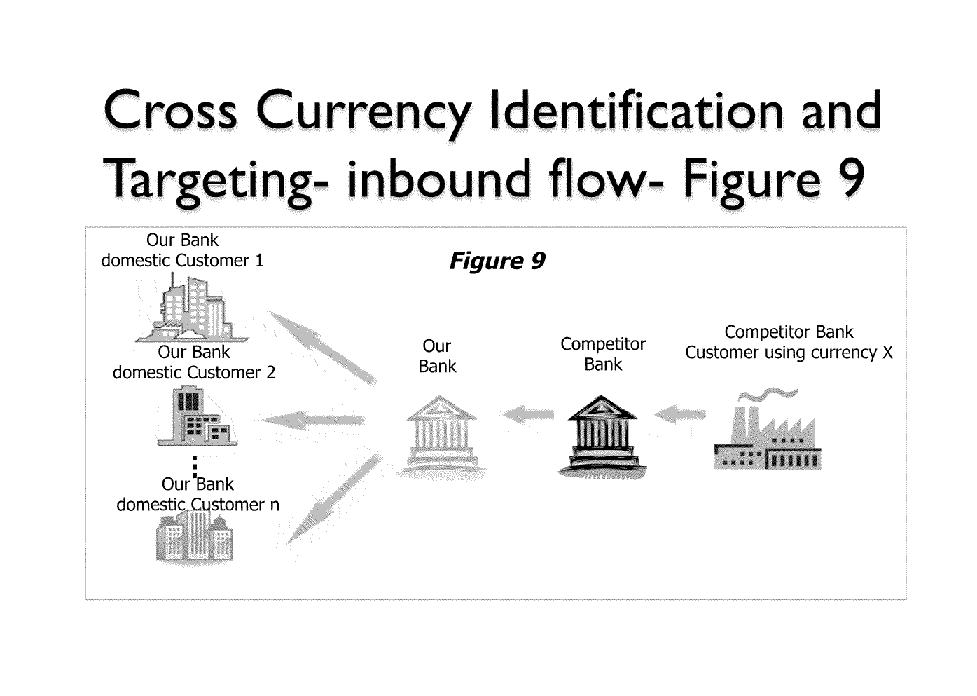

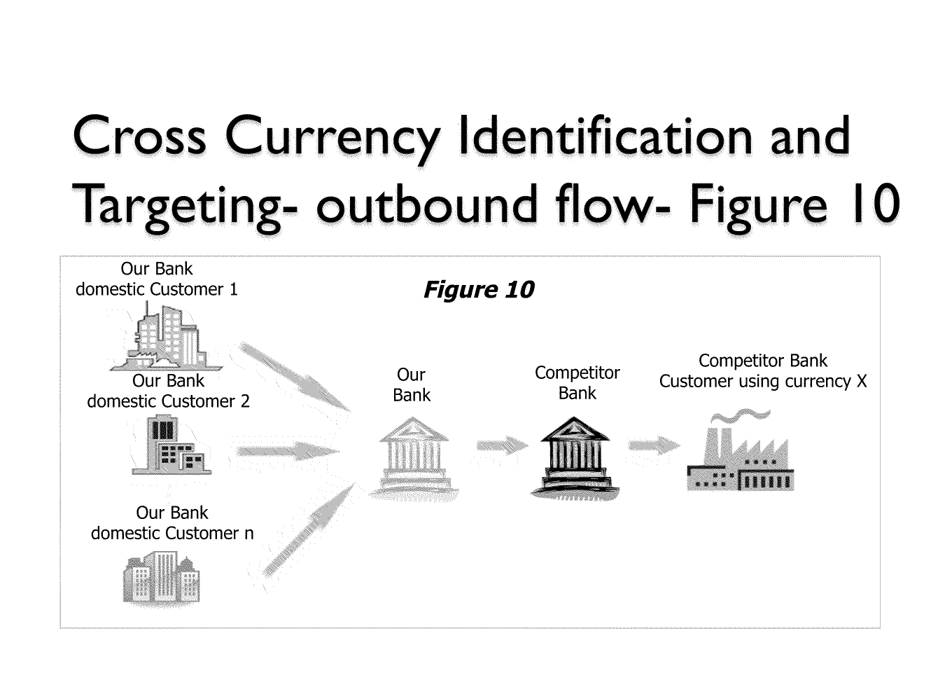

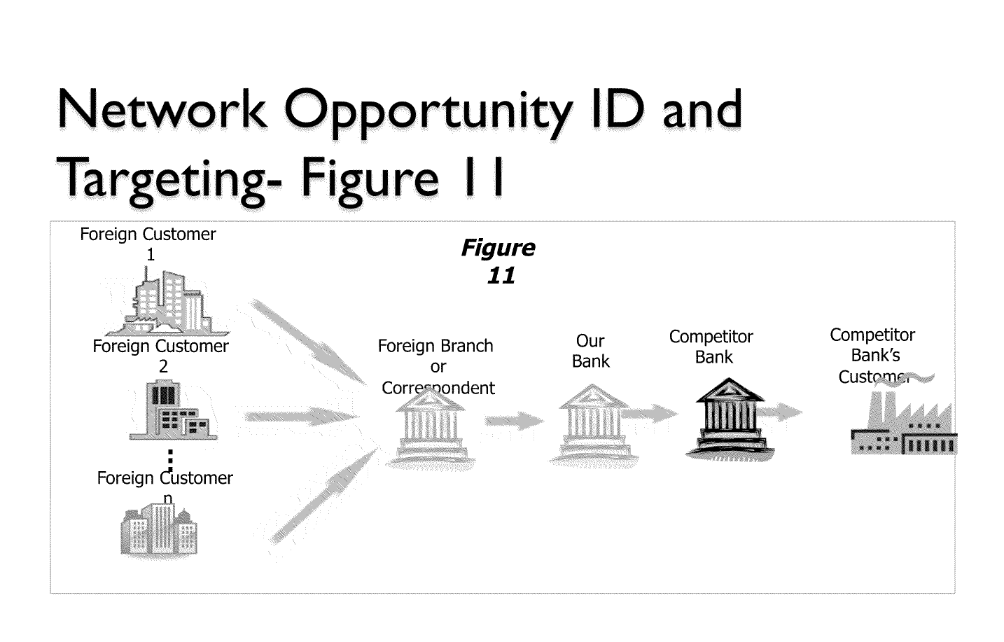

Now referring to FIGS. 9 & 10, an inbound and an outbound cross currency identification and targeting payment flow diagrams are shown.

### CB.7 Corporate Banking: Cross Currency Opportunity Identification and Targeting

Refer to FIG. CB.7. Purpose: To identify potential new customers or expand our customer relationship who have a significant volume of payment activity in one currency but not in another. We will look at company, parent, and ultimate parent.

Pattern Steps: (Based on SWIFT MT103 fields and the customer information file)
1. On an outbound payment list top 10% of payment customers by currency. CLEAN
2. Is the Company, Parent, or Ultimate Parent a Target_Country based company from the CIF?

If No, go to next record.

If yes go to step 3.

### SELECT CURRENCY

### 3. Go to Mapping # “8 Corporate Banking: Competitive Wallet Share Analyzer”.

Now referring to FIG. 11 a network opportunity identification and targeting flow diagram is shown.

13. Corporate Banking: Network Opportunity Identification and Targeting Refer to FIG. CB.8. Purpose: To identify potential new customers who have a significant volume of payment activity from our customers. This pattern will identify the top prospects based on volume of payments. It can be extended to show top Customer to Beneficiary pairs.
Pattern Steps: (Based on SWIFT MT103 fields and the customer information file)
1. Is the Beneficiary Customer an existing customer?

Is field 59A=customer in our CIF?

If Yes then go to next record.

If No. Go to step 2.

2. Save record to Database

Fields

32A—Value Date and Amount

50A—Ordering Customer

51A—Sending Institution

52A—Ordering Institution

53A—Senders Correspondent

56A—Intermediary Institution

57A—Account With Institution

59A—Beneficiary Customer

### Analytical Steps:

Ranking Order for Highest Potential New Customer based on Volume of Payments. Will aggregate the number of payments by Beneficiary Customer.

### Action Steps:

Sort by 59A
If value date minus the current date is less than 90 days count the number of payments (from field 32A)
Take number of payment by each 59A and divide by total number of payments from top 100 to derive % of total by each beneficiary.
Show cumulative % of total for top 2, 3, 4, 5 etc.

| Benificiary | | % of | Cumulative |
|---|---|---|---|
| Customer | Total number of payments 90 days | Total | % of Total |
| Propsect A | 11,005 | 5% | 5% |
| Prospect B | 8,025 | 4% | 9% |
| Prospect C | 7,800 | 4% | 13% |
| Prospect D | 5,800 | 3% | 16% |
| Total top 100 | 205,000 | | |

Sort by 50A (Ordering Party) to show relationship between Ordering Customer and Beneficiary Customer.

| Benificiary | Total number of payments 90 days | % of | Cumulative |
|---|---|---|---|
| Customer | from a specfic Ordering Customer | Total | % of Total |
| Propsect A | 650 | 7% | 7% |
| Prospect B | 520 | 5% | 12% |
| Prospect C | 310 | 3% | 15% |
| Prospect D | 295 | 3% | 18% |
| Total top 100 | 9,800 | | |

### Financial Institution Patterns

Refer to FIG. FI.1. Anti-money laundering (AML) is a term mainly used in the financial and legal industries to describe the legal controls that require financial institutions and other regulated entities to prevent or report money laundering activities. Anti-money laundering guidelines came into prominence globally after the Sep. 11, 2001 attacks and the subsequent enactment of the USA PATRIOT Act.

Know your customer (KYC) is the due diligence and bank regulation that financial institutions and other regulated companies must perform to identify their clients and ascertain relevant information pertinent to doing financial business with them. In the USA, KYC is typically a policy implemented to conform to a customer identification program mandated under the Bank Secrecy Act and USA PATRIOT Act. Know your customer policies have becoming increasingly important globally to prevent identity theft fraud, money laundering and terrorist financing. In a simple form these rules may equate to answering twelve questions, but this is the tip of the iceberg and regulators now expect much more. KYC should not be thought of as a form to be filled—it is a process to be undergone from the start of a customer relationship to the end.

Wallet share measures the proportion of a customer's total holdings, revenue stream or business value that the bank or financial institution captures. As such, it gauges the bank's penetration of its own customer base.

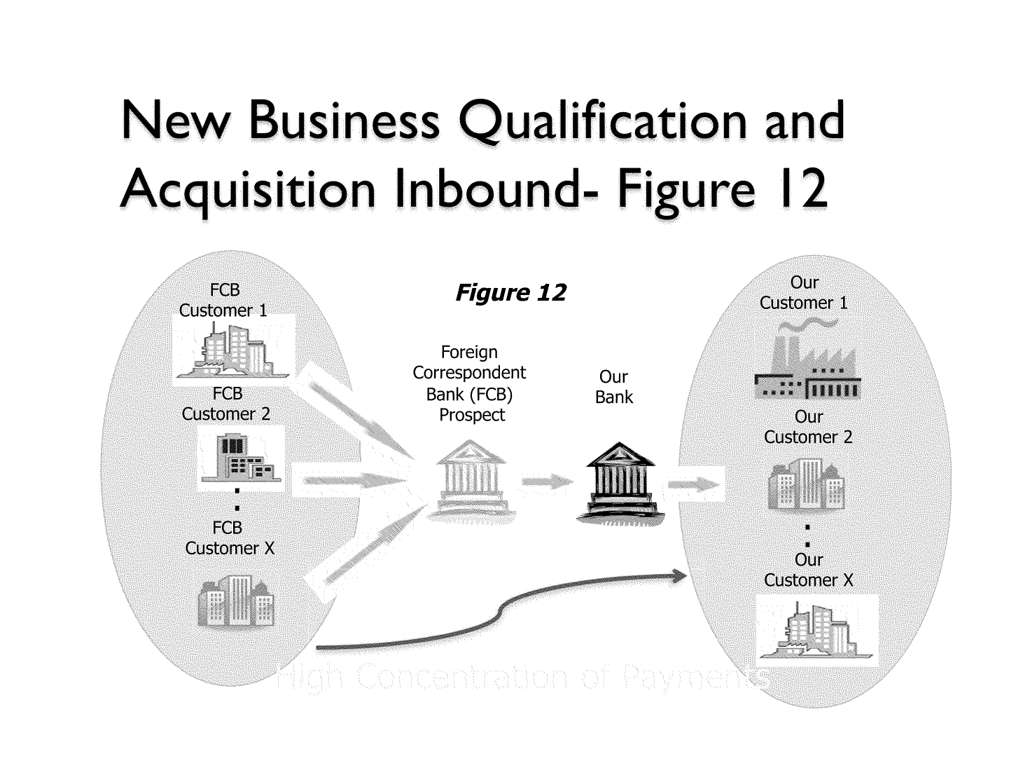

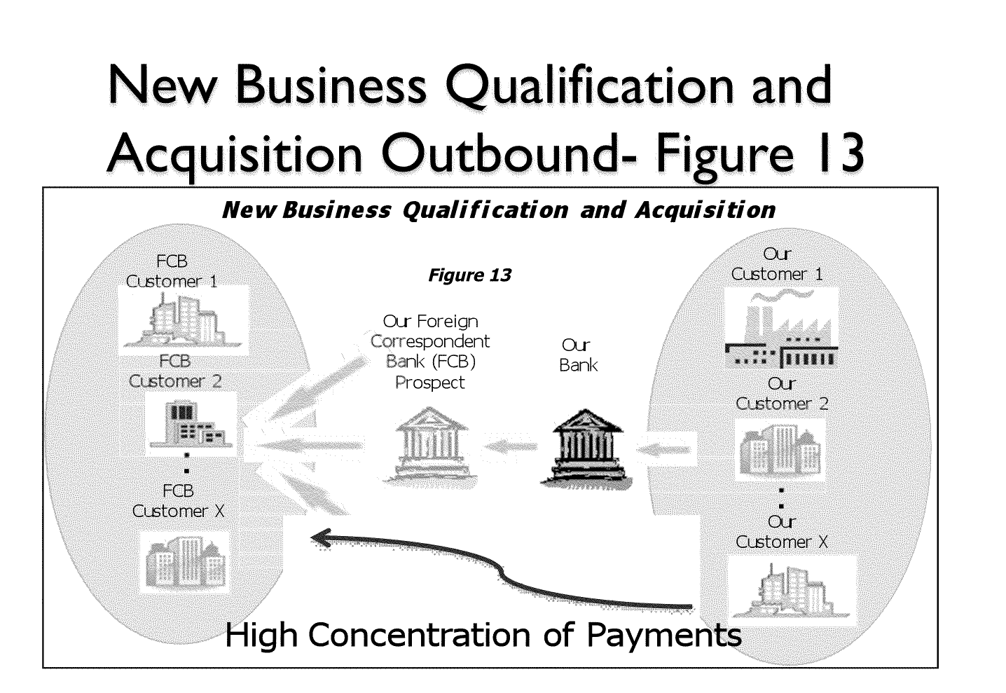

Now referring to FIGS. 12 & 13, an inbound and an outbound new business qualification and acquisition payment flow diagrams are shown.

### FI.1 Correspondent Banking: New Business Qualification and Acquisition

Purpose: To identify potential new correspondent bank customers who have a significant volume of payment activity between that bank's customer and our customers. This pattern will identify the top prospects based on volume of payments as well as trend in payment volumes. It will also identify specific customer patterns that are driving existing volumes and trends in volume.

Refer to FIG. FI.1-1. Pattern Steps: (Based on SWIFT MT103 fields and the customer information file (CIF))
1. Is the sending institution not a customer?

Is field 51A not a match to a customer name in our CIF?

If Yes then Go to Step 2.

If No. Go to next record.

This step is hereafter called Correspondent_Not_In_CIF
2. Save record to the Correspondent_Banking_New_Business_File

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Ranking Order for Highest Potential New Customer based on Volume of Payments. Will aggregate the number of payments by Sending Institution and show historical trends.

### Action Steps: Refer to FIG. FI.1A.

Sort Correspondent_Banking_New_Business File by 51A
Tally Data
   If value date minus the current date is less than 30 days, count the number of payments and store in 30_Day_Data_Count field.
   If value date minus the current date is less than 90 days, count the number of payments and store in 90_Day_Data_Count field.
   If value date minus the current date is less than 180 days, count the number of payments and store in 180_Day_Data_Count field.
   If value date minus the current date is less than 365 days, count the number of payments and store in 365_Day_Data_Count field.
(Here after called Tally_Data_Date_{—}30_{—}90_{—}180_{—}365)
Sum 180_Day_Data_Count field for all 51A and store in a 180_Day_Total_Payments field.
Divide each unique 51A 180_Day_Data_Count field by 180_Day_Total_Payments to derive percent of total by each sending institution and store in 180_Day_Percent field.
Sort row by Descending based on 180_Day_Count field.
For each row, compute Cumulative_Percent by adding 180_Day_Percent field to the 180_Day_Percent field on the row above and place in Cumulative_Percent filed.
For each row, take the 30_Day_Data_Count field, divide by the Number_Business_Days_Last_{—}30_Days (Taken from the Investigation System) and store in field Average_Last_{—}30_Days.
For each row, take the 90_Day_Data_Count field, divide by the Number_Business_Days_Last_{—}90_Days (Taken from the Investigation System) and store in field Average_Last_{—}90_Days.
For each row, take the 180_Day_Data_Count field, divide by the Number_Business_Days_Last_{—}180_Days (Taken from the Investigation System) and store in field Average_Last_{—}180_Days.
For each row, take the 365_Day_Data_Count field, divide by the Number_Business_Days_Last_{—}365_Days (Taken from the Investigation System) and store in field Average_Last_{—}365_Days.

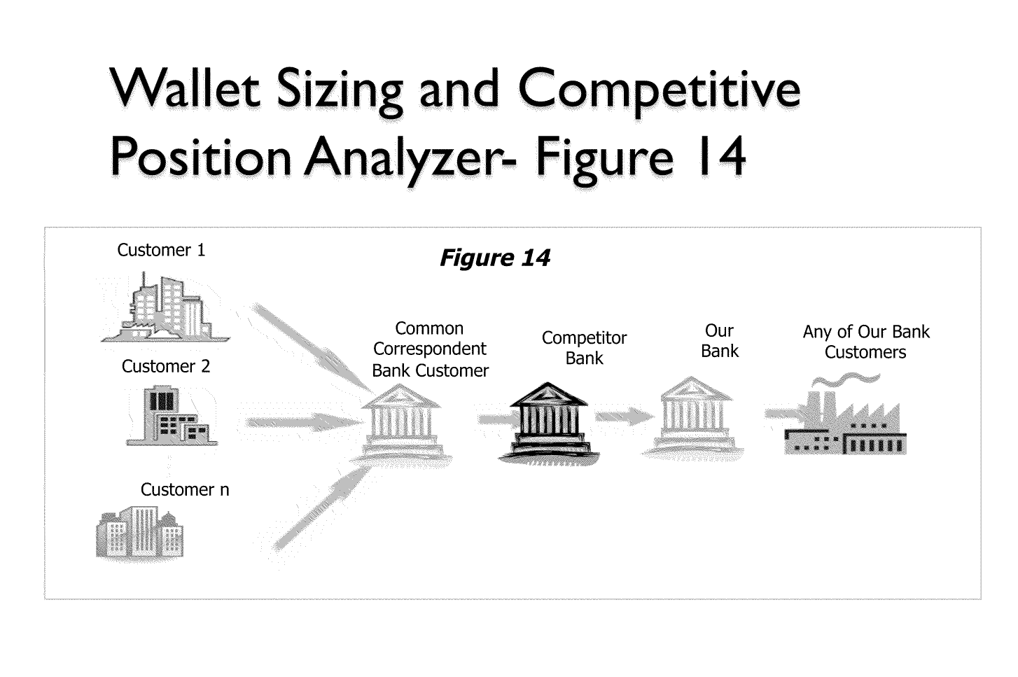

Now referring to FIG. 14 a wallet sizing and competitive position analyzer flow diagram is shown.

### FI.2 Correspondent Banking: Wallet Sizing and Competitive Position Analyzer

Refer to FIG. FI.2. Purpose: To estimate wallet size of correspondent bank's payments relative shares by competitors versus ours.

Refer to FIG. FI.2-1. Pattern Steps: (Based on SWIFT MT103 fields and the customer information file)
1. Is the sending institution an existing customer?

Is field 51A=customer in our CIF?

If Yes Go to Step 2.

If No. Go to next record.

This step is hereafter called Correspondent_In_CIF
2. Is the Sender's Correspondent one of our competitors (from speCIFied list supplied by bank)?

Is field 53A is on the Competitor_List?

if yes include go to step 3.

if no, move to next record

3. Save record to Correspondent_Banking_Wallet_Sizing file

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Identify the commercial payment volume percentage for each competitor who sends payments to us on behalf a correspondent bank who is our customer.

### Action Steps: Refer to FIG. FI.2A.

Get our bank's market share from Clearing and Settlement Entity (e.g., fedwire, TCH, EBA, ECB, LVTS) and store in Market_Share field.
Take records in the Correspondent_Banking_Wallet_Sizing file and sort by 51A (Sending Institution)
Tally_Data_Date_{—}30_{—}90_{—}180_{—}365
Use 30_Day_Data_Count for each Sending Institution and array by institution in the Competitor_List to form the Sending_Insitution_By_Competitor_{—}30_Day field.
Populate Competitor_Volume_{—}30_Day field by dividing the Sending_Insitution_By_Competitor_{—}30_Day field by the Market_Share field for each competitor.
For each Sending_Insitution list our Debit_Volume for that institution over the past 30 days (taken from the bank's wire transfer system) and populate the Debit_Volume_By_Sending_Institution_{—}30_Day field.
For each Sending_Insitution sum the Competitor_Volume_{—}30_Day for each competitor and Debit_Volume_By_Sending_Institution_{—}30_Day and place in a Total_Volume_{—}30_Day field.
For each Sending_Insitution compute Competitor_Market_Share by taking Competitor_Volume_{—}30_Day and dividing it by the Total_Volume_{—}30_Day and populate in the Competitor_Market_Share_{—}30_Day field.

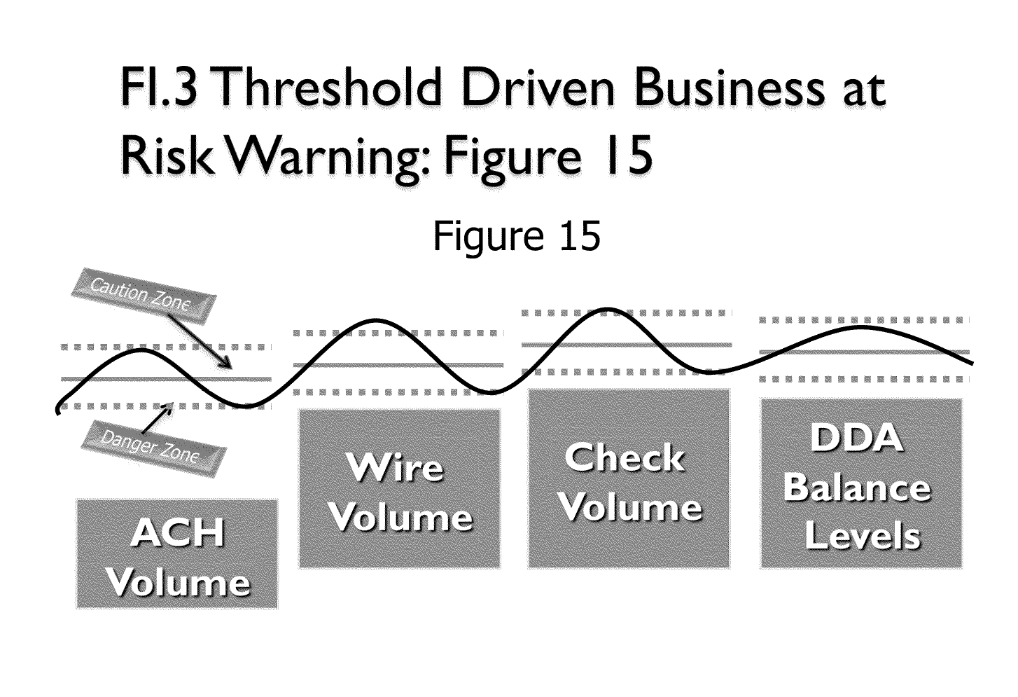

Now referring to FIG. 15 a threshold driven business at risk warning flow diagram is shown.

### FI.3 Correspondent Banking: Threshold-driven “Business At Risk” Warning System

Refer to FIG. FI.3. Purpose: To identify customer relationships at risk of significantly declining volumes or lost relationship.

Refer to FIG. FI.3-1. Pattern Steps: (Based on SWIFT MT103 fields and the customer information file)
1. Is the sending institution an existing customer?

Correspondent In CIF?

If Yes Go to Step 2.

If No. Go to next record.

2. Is the Sender's Correspondent one of our competitors (from speCIFied list supplied by bank)?

Is field 53A is on the Competitor_List?

if yes include go to step 3.

if no, move to next record

3. Save record in Business_At_Risk file

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Identify what percentage each of our competitors has of our correspondent bank's commercial payment volume and who is trending up or down.

### Action Steps: Refer to FIG. FI.3A.

Take records in the Business_At_Risk file and sort by 51A (Sending_Institution).
Tally Data 30, 90, 180 days
   If value date minus the current date is less than 30 days, count the number of payments and store in 30_Day_Data_Count field.
   If value date minus the current date is less than 90 days, count the number of payments and store in 90_Day_Data_Count field.
   If value date minus the current date is less than 180 days but greater than 90 days count the number of payments and store in 90_{—}180_Day_Data_Count field.
(Here after called Tally_Data_Date_{—}30_{—}90_{—}90_{—}180)
Use 30_Day_Data_Count for each Sending_Institution and array by institution in the Competitor_List to form the Sending_Insitution_By_Competitor_{—}30 Day field.
Use 90_Day_Data_Count for each Sending_Institution and array by institution in the Competitor_List to form the Sending_Insitution_By_Competitor_{—}90 Day field.
Use 180_Day_Data_Count for each Sending_Institution and array by institution in the Competitor_List to form the Sending_Insitution_By_Competitor_{—}180 Day field.
For each Sending_Insitution list our Debit_Volume for that institution over the past 30 days (taken from the bank's wire transfer system) and populate the Debit_Volume_By_Sending_Institution_{—}30_Day field.
For each Sending_Insitution list our Debit_Volume for that institution over the past 90 days (taken from the bank's wire transfer system) and populate the Debit_Volume_By_Sending_Institution_{—}90_Day field.
For each Sending_Insitution list our Debit_Volume for that institution over the past 91-180 days (taken from the bank's wire transfer system) and populate the Debit_Volume_By_Sending_Institution_{—}180_Day field.
For each Sending_Insitution sum the Competitor_Volume_{—}30_Day for each competitor and Debit_Volume_By_Sending_Institution_{—}30_Day and place in a Total_Volume_{—}30 Day field.
For each Sending_Insitution sum the Competitor_Volume_{—}90_Day for each competitor and Debit_Volume_By_Sending_Institution_{—}90_Day and place in a Total_Volume_{—}90 Day field.
For each Sending_Insitution sum the Competitor_Volume_{—}180_Day for each competitor and Debit_Volume_By_Sending_Institution_{—}180_Day and place in a Total_Volume_{—}180 Day field.
For each Sending_Insitution compute Competitor_Market_Share by taking Competitor_Volume_{—}30_Day and dividing it by the Total_Volume_{—}30 Day and populate in the Competitor_Market_Share_{—}30_Day field.
For each Sending_Insitution compute Competitor_Market_Share by taking Competitor_Volume_{—}90_Day and dividing it by the Total_Volume_{—}90_Day and populate in the Competitor_Market_Share 90_Day field.
For each Sending_Insitution compute Competitor_Market_Share by taking Competitor_Volume_{—}180_Day and dividing it by the Total_Volume_{—}180_Day and populate in the Competitor_Market_Share_{—}180_Day field.
For each Sending_Insitution compute Our_Market_Share by taking Debit_Volume_By_Sending_Institution_{—}30_Day and dividing it by the Total_Volume_{—}30_Day and populate in the Our_Market_Share_{—}30_Day field.
For each Sending_Insitution compute Our_Market_Share by taking Debit_Volume_By_Sending_Institution_{—}90_Day and dividing it by the Total_Volume_{—}90_Day and populate in the Our_Market_Share_{—}90_Day field.
For each Sending_Insitution compute Our_Market_Share by taking Debit_Volume_By_Sending_Institution_{—}180_Day and dividing it by the Total_Volume_{—}180_Day and populate in the Our_Market_Share 180 Day field.
Highlight changes in Competitor_Market_Share_{—}30_Day and Competitor_Market_Share_{—}90_Day where Competitor_Market_Share_{—}30_Day minus Competitor_Market_Share_{—}90_Day is greater than Threshold_Amount. (Manual input).
Highlight changes in Competitor_Market_Share_{—}90_Day and Competitor_Market_Share_{—}180_Day where Competitor_Market_Share_{—}90_Day minus Competitor_Market_Share_{—}180_Day is greater than Threshold_Amount. (Manual input).
Highlight changes in Our_Market_Share_{—}30_Day and Our_Market_Share_{—}90_Day where Our_Market_Share_{—}90_Day minus Our_Market_Share_{—}30_Day is greater than Threshold_Amount. (Manual input).
Highlight changes in Our_Market_Share_{—}90_Day and Our_Market_Share_{—}180_Day where Our_Market_Share_{—}180_Day minus Our_Market_Share_{—}90_Day is greater than Threshold_Amount. (Manual input).

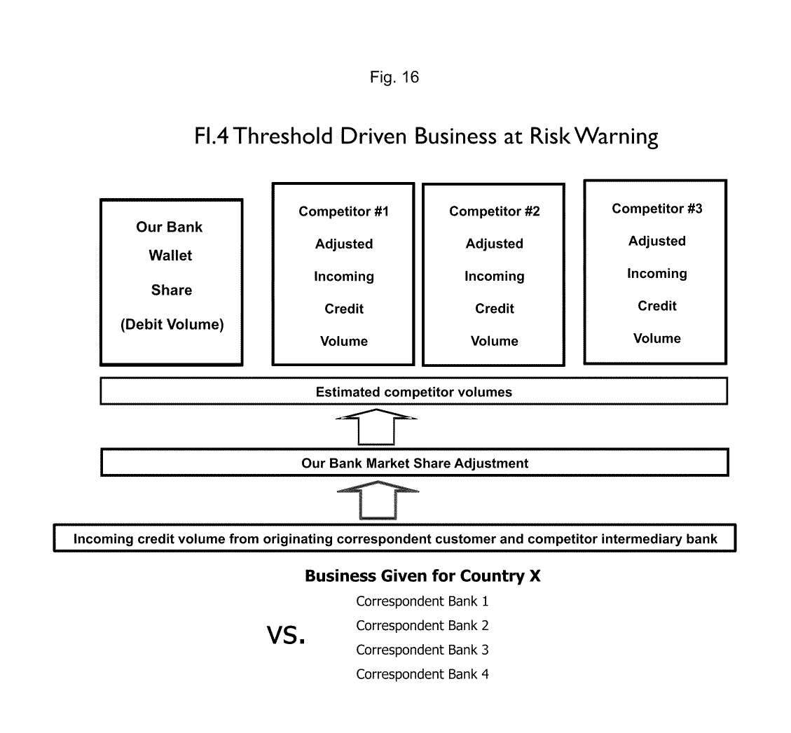

Now referring to FIG. 16 a threshold driven business at risk warning flow diagram is shown.

### FI.4 Correspondent Banking: Reciprocity Analyzer

Refer to FIG. FI.4. Purpose: To identify how much business we are giving to our correspondent bank in relation to the trend in business they are giving us versus our competitors.

Refer to FIG. FI.4-1. Pattern Steps: (Based on SWIFT MT103 fields and the customer information file)
1. Is the sending institution an existing customer?

Correspondent In CIF?

If Yes Go to Step 2.

If No. Go to next record.

2. Is the Sending Institution in our Nostro_Account database?

Is field 51A=Nostro_Account_Bank (take from corporate list of Nostro Banks)
If no move to next record
If yes move to step 3
   3. Is the Sending Institution from the country we are analyzing?

Input Search_County_Code

Look at 51A for BIC

Cross ref to Customer Information File for BIC to Country_Code

Does Country_Code match Search_Country_Code
If no move to next record
If yes include send file to Reciprocity_Analyzer file
   4. Save record to Reciprocity_Analyzer Database

Fields

32A—Value Date and Amount

50A—Ordering Customer

51A—Sending Institution

52A—Ordering Institution

53A—Senders Correspondent

56A—Intermediary Institution

59A—Beneficiary Customer

### Analytical Steps:

Identify trends where the correspondent is sending a Payment Message through a correspondent.

### Action Steps Refer to FIG. FI.4A.

Take records in the Reciprocity_Analyzer file and sort by 51A (Sending_Institution).
Tally_Data_Date_{—}30_{—}90_{—}90_{—}180 and array.
For each row, take the 30_Day_Data_Count field, divide by the Number_Business_Days_Last_{—}30 Days (Taken from the Investigation System) and store in field Average_Last_{—}30_Days.
For each row, take the 90_Day_Data_Count field, divide by the Number_Business_Days_Last_{—}90_Days (Taken from the Investigation System) and store in field Average_Last_{—}90_Days.
For each row, take the 90_{—}180_Day_Data_Count field, divide by the Number_Business_Days_Last_{—}180_Days minus Number_Business_Days_Last_{—}90_Days (Taken from the Investigation System) and store in field Average_Last_{—}90_{—}180_Days.
For each Nostro_Account_Bank list our Debit_Volume for that institution over the past 30 days (taken from the bank's wire transfer system) and populate the Debit_Volume_By_Sending_Institution_{—}30_Day field.
For each Nostro_Account_Bank list our Debit_Volume for that institution over the past 90 days (taken from the bank's wire transfer system) and populate the Debit_Volume_By_Sending_Institution_{—}90_Day field.
For each Nostro_Account_Bank list our Debit_Volume for that institution over the past 91-180 days (taken from the bank's wire transfer system) and populate the Debit_Volume_By_Sending_Institution_{—}180_Day field.
For each row, take the Debit_Volume_By_Sending_Institution_{—}30_Day, divide by the Number_Business_Days_Last_{—}30_Days (Taken from the Investigation System) and store in field Debit_Volume_Average_Last_{—}30_Days.
For each row, take the Debit_Volume_By_Sending_Institution 90 Day, divide by the Number_Business_Days_Last_{—}90_Days (Taken from the Investigation System) and store in field Debit_Volume_Average_Last_{—}90_Days.
For each row, take the Debit_Volume_By_Sending_Institution_{—}90_{—}180_Day, divide by the Number_Business_Days_Last_{—}90_{—}180_Days (Taken from the Investigation System) and store in field Debit_Volume_Average_Last_{—}90_{—}180_Days.
For each row take the Debit_Volume_Average_Last_{—}30_Days and divide it by the Average_Last_{—}30_Days to compute the Reciprocity_{—}30 field.
For each row take the Debit_Volume_Average_Last_{—}90_Days and divide it by the Average_Last_{—}90_Days to compute the Reciprocity_{—}90 field.
For each row take the Debit_Volume_Average_Last_{—}90_{—}180_Days and divide it by the Average_Last_{—}90_{—}180_Days to compute the Reciprocity_{—}180 field.

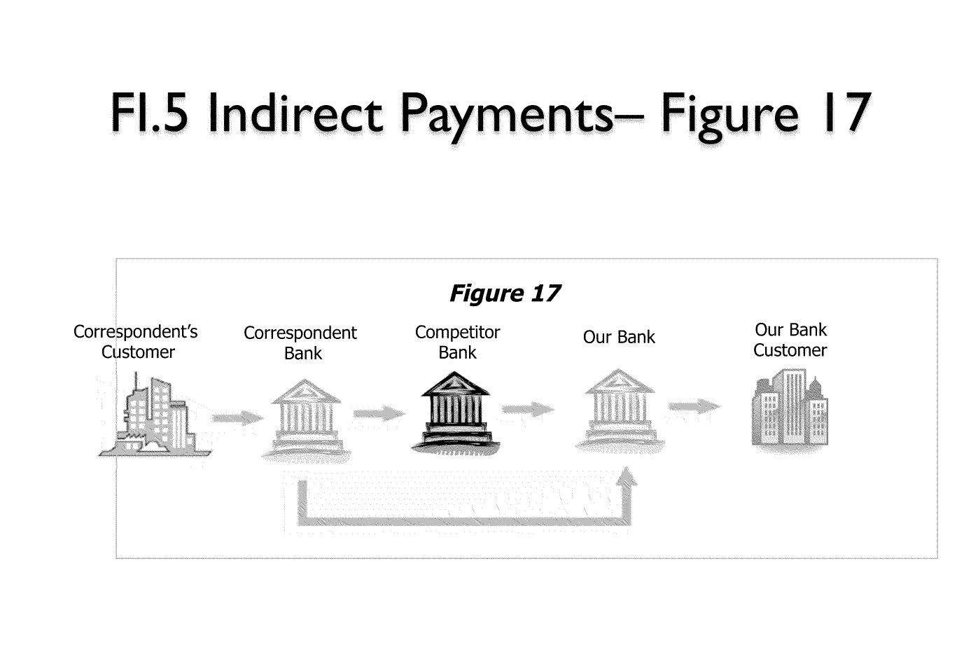

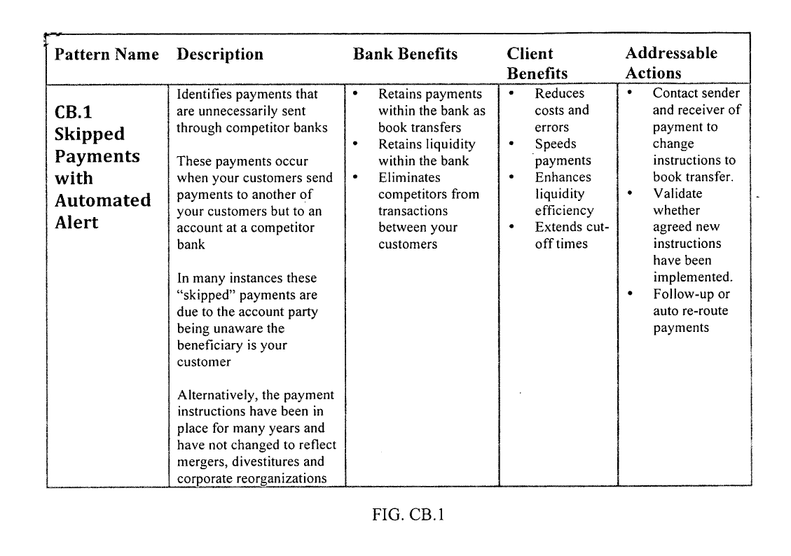

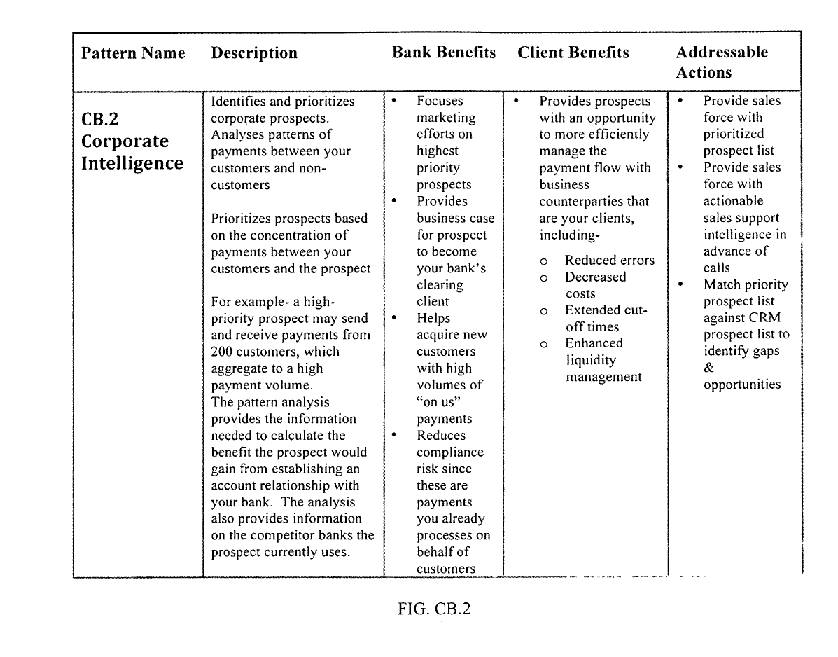

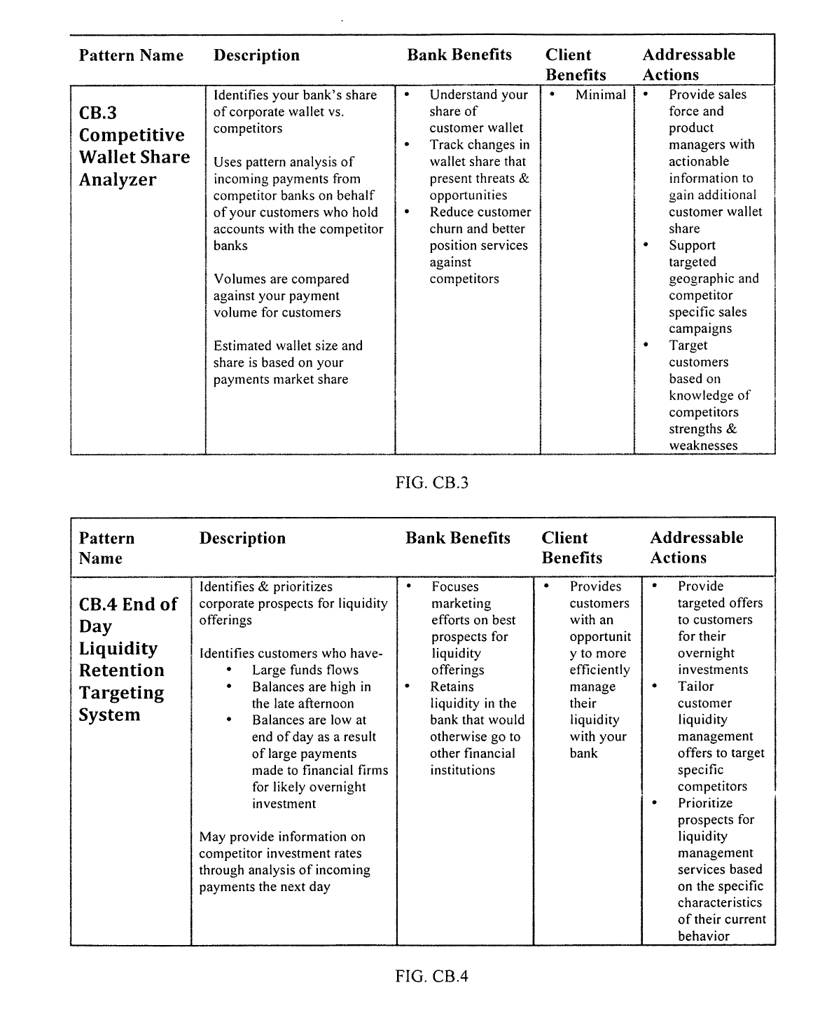

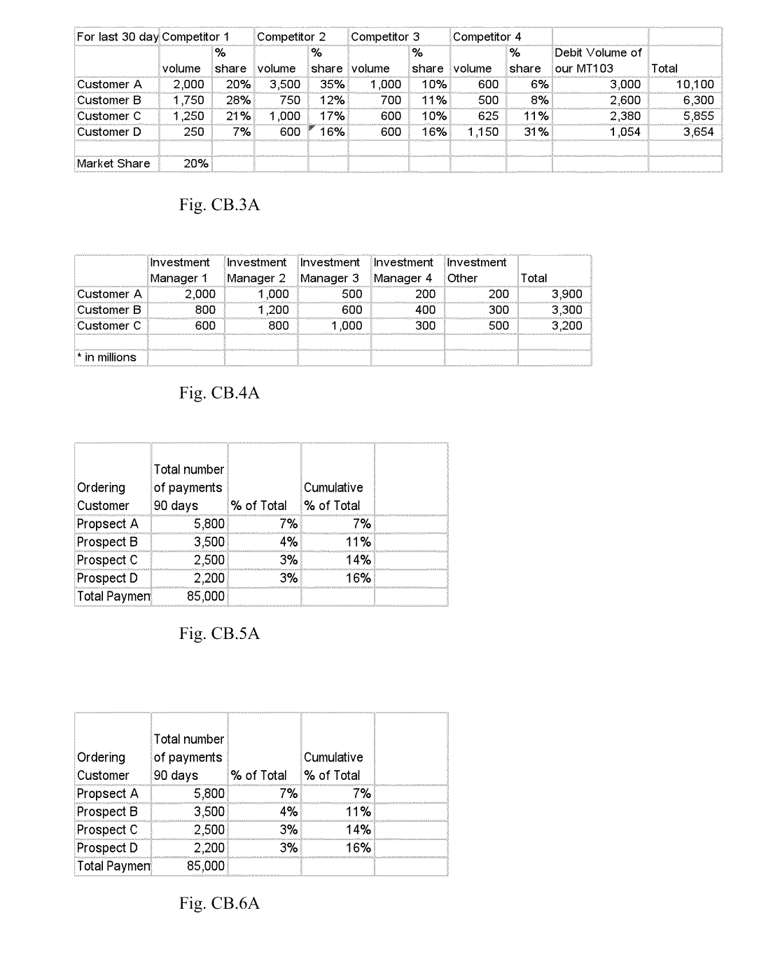

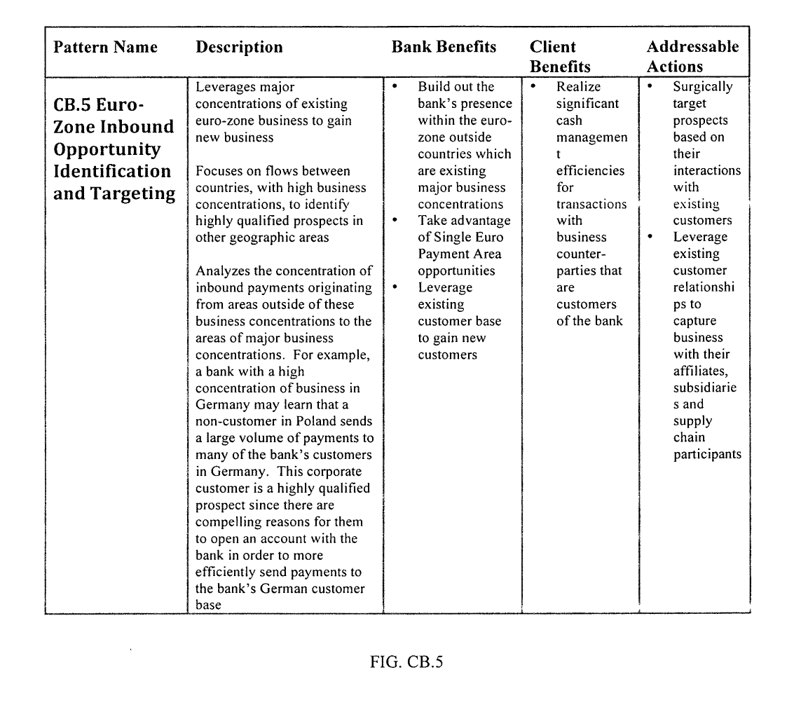

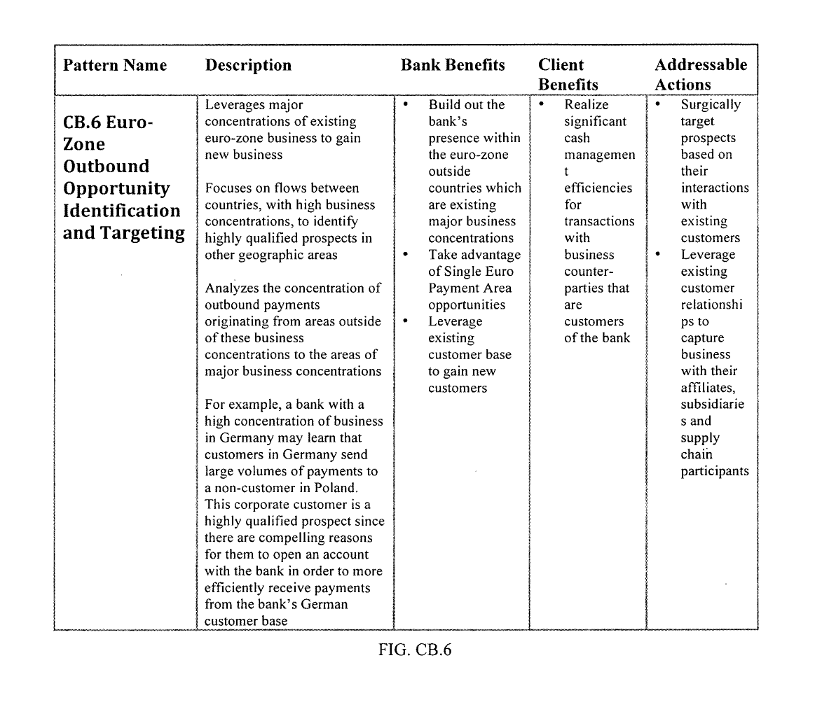

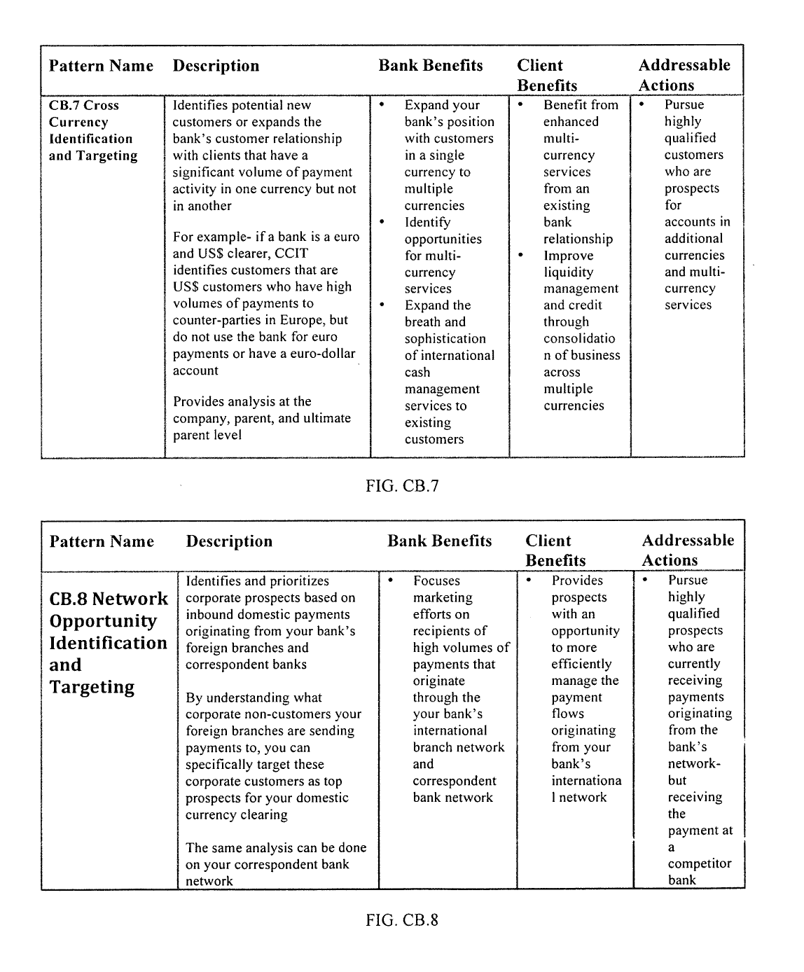

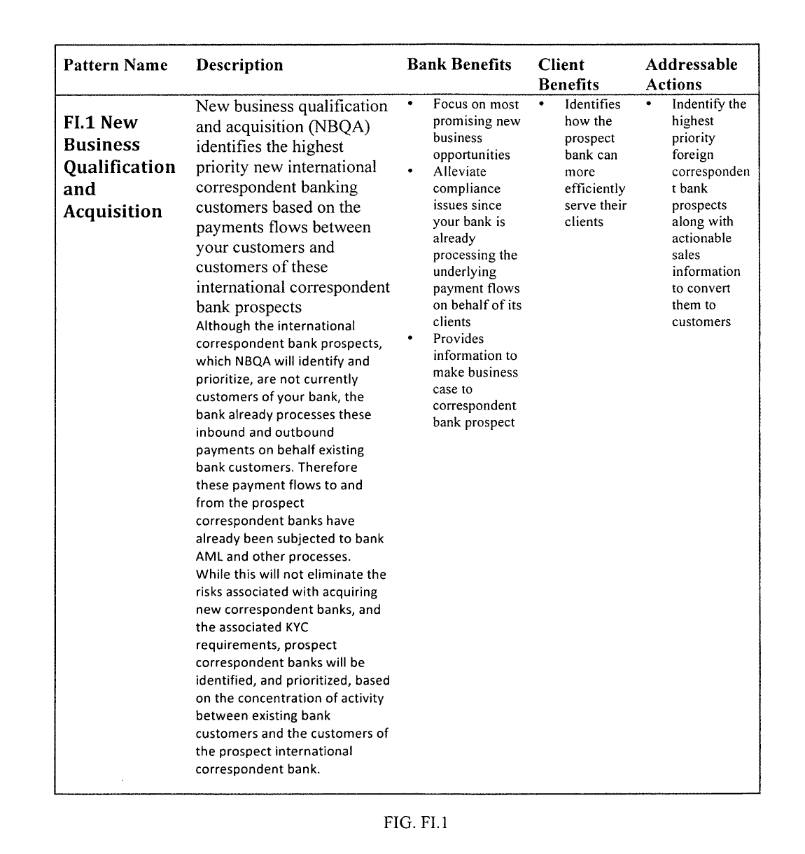

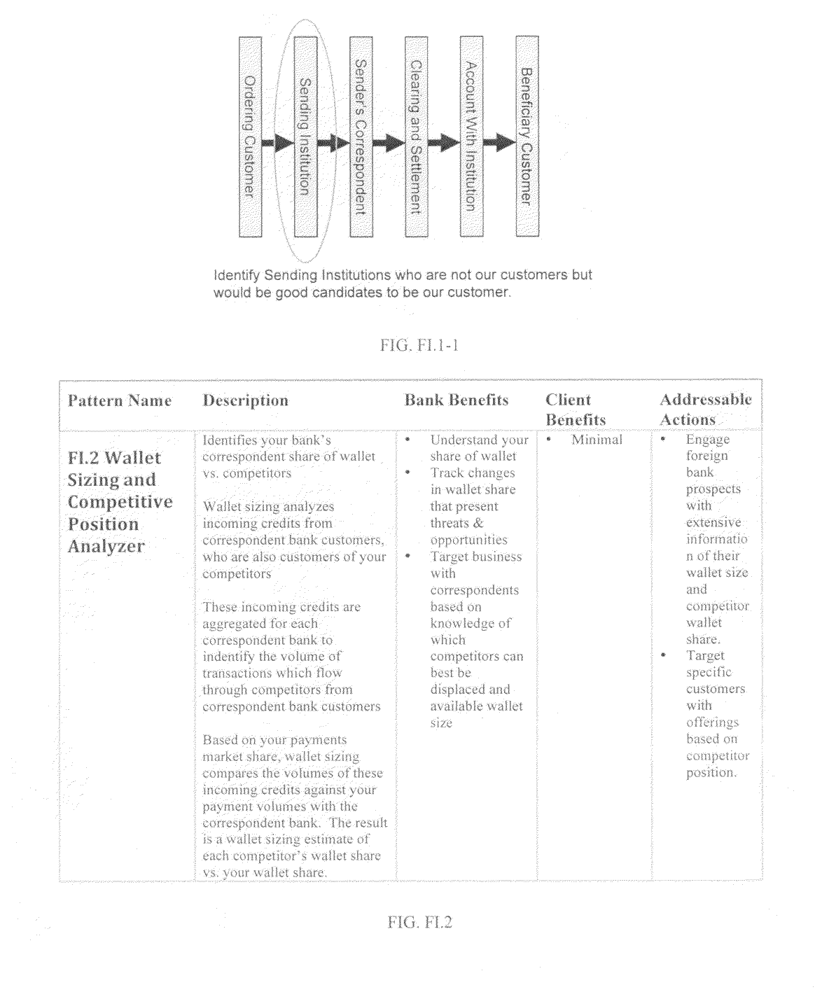

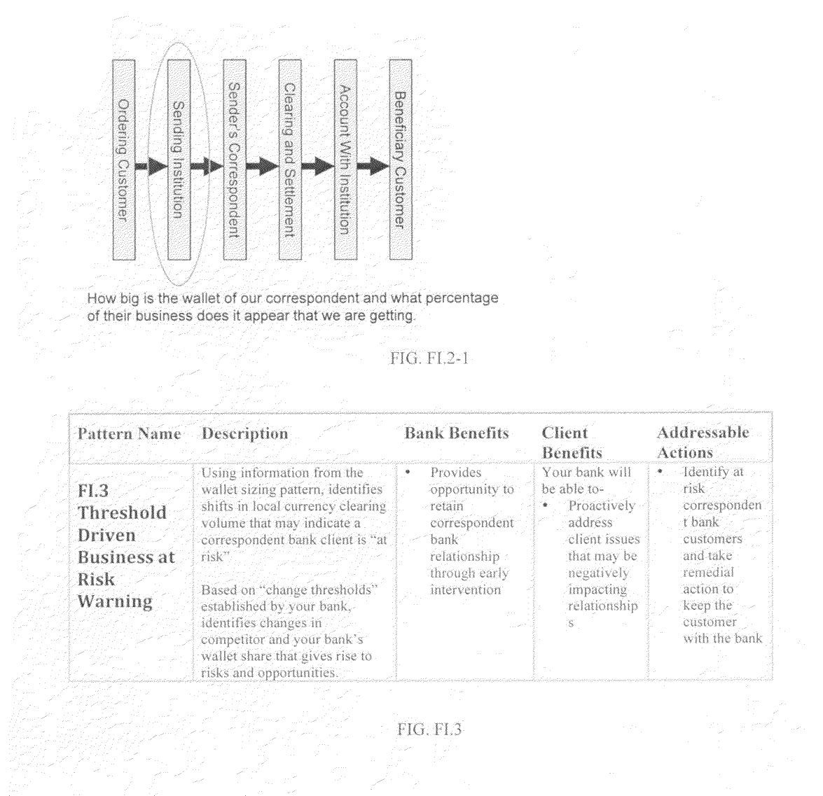

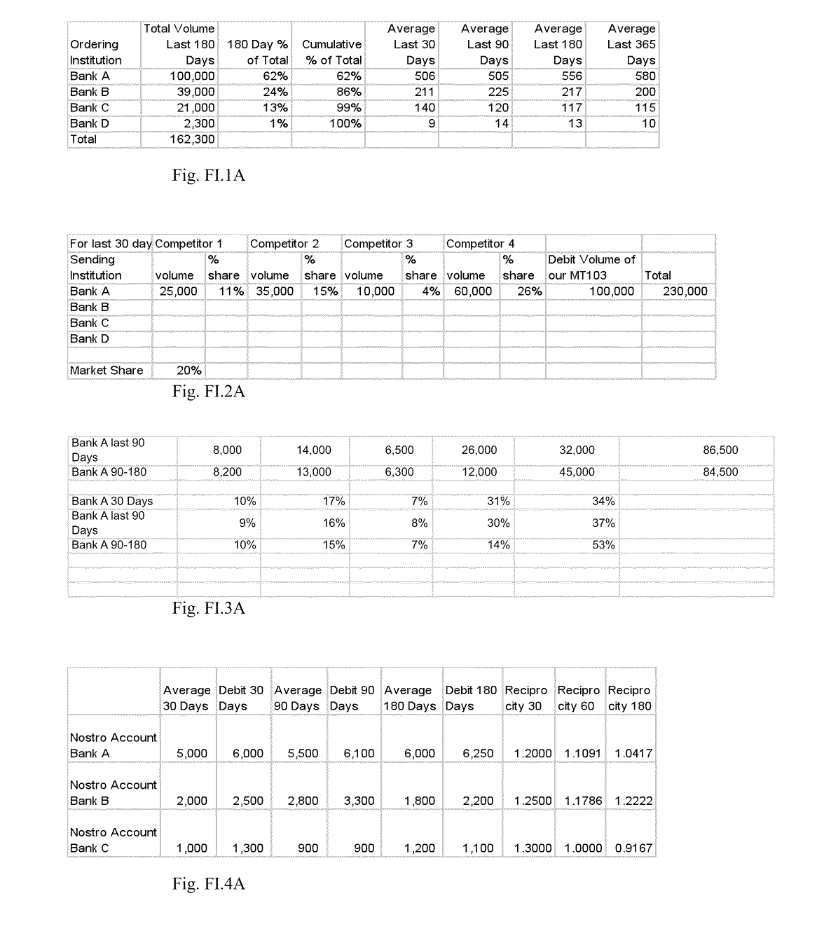

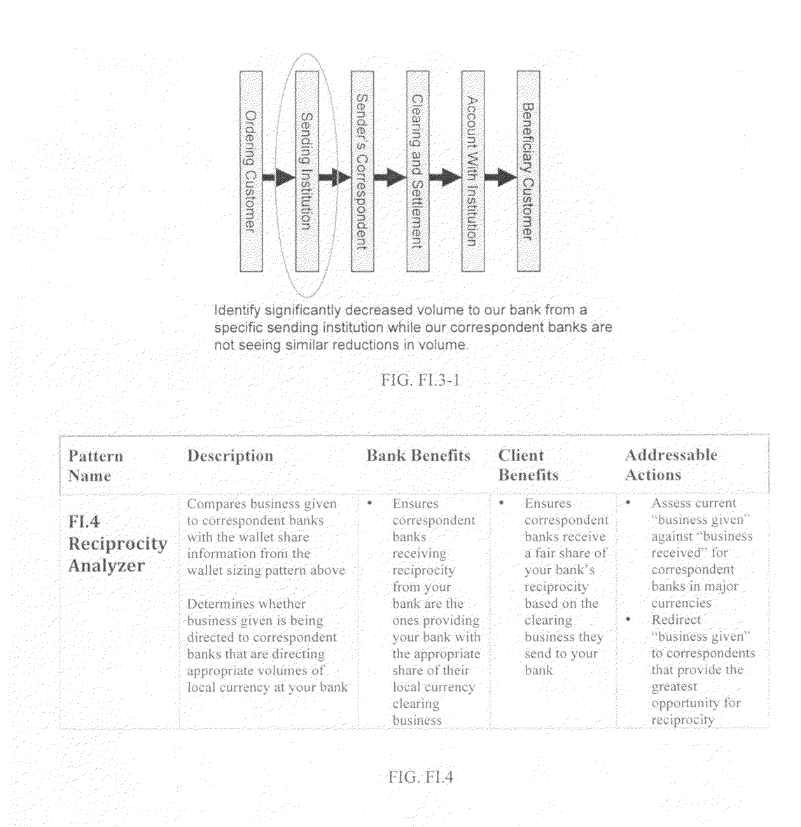

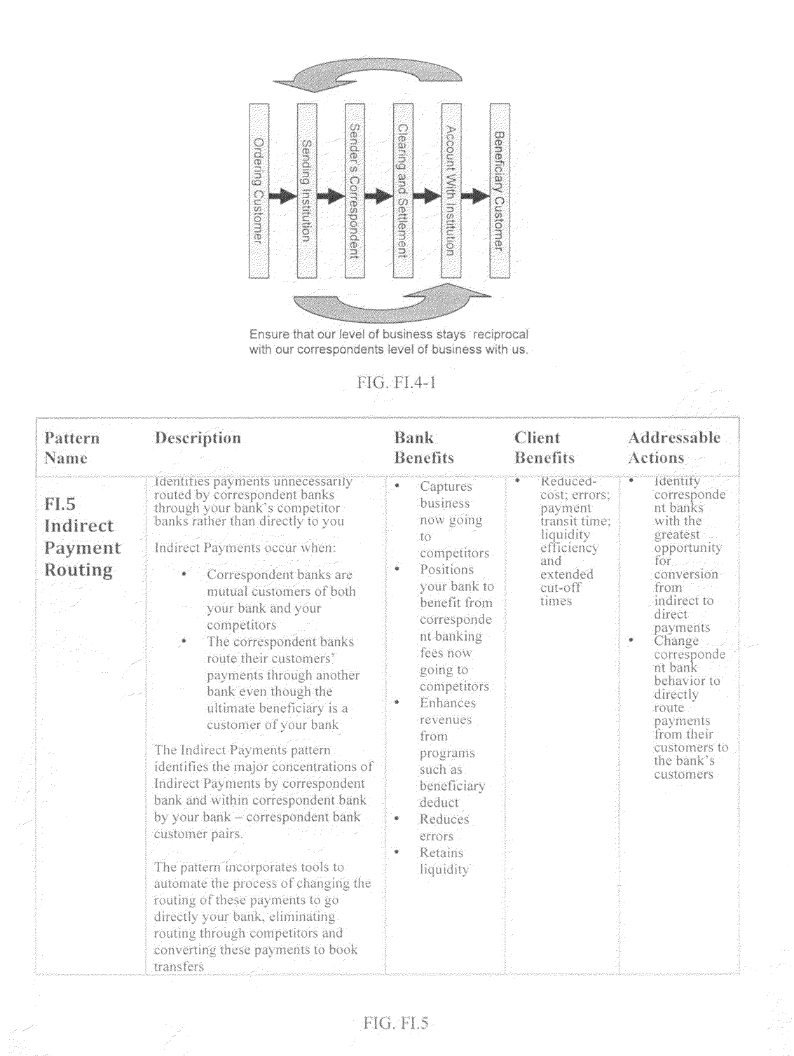

Now referring to FIG. 17 an indirect payment flow diagram is shown.

### FI.5 Correspondent Banking: Indirect Payment Routing Identification With Automated Alert

Refer to FIG. FI.5. Purpose: To identify when a correspondent bank who has a relation with us is instead sending a payment to our customer through an intermediary bank who is our competitor which is then routed to us for payment on our books.

Pattern Steps: (Based on SWIFT MT103 fields and the customer information file).
Inbound payment going to our customer that are not book transfers.
1. Is the sending institution an existing customer?

Correspondent In CIF?

If Yes Go to Step 2.

If No. Go to next record.

2. Is there an intermediary bank (Field 56A)?

if yes include go to step 3.

if no, move to next record

3. Save record in Indirect Payment file

### Fields

Originating bank reference number

Date (32A)

Time (32A)

Amount (32A)

Account party bank name (Sending Institution 51A)

Account party bank country code (51A)

Account party bank BIC (51A)

Account party name (50K)

Account party address (50K)

Account party country (50K)

Competitor (intermediate) bank name (56A)

Competitor bank BIC (56A)

Competitor bank country (56A)

Beneficiary name (Beneficiary Customer 59A)

Beneficiary ID (Our bank customer ID) (59A)

### Analytical Steps:

Identify the number of payments our correspondent banks are sending to us for payment on our books through a competitor bank.

### Action Steps:

Take records in the Indirect_Payment file and sort by 51A (Sending_Institution), then by Beneficiary Customer (59A), then by Intermediary Institution (56A).
Tally Data 30, 90, 180 days
   If value date minus the current date is less than 30 days, count the number of payments and store in 30_Day_Data_Count field.
   If value date minus the current date is less than 90 days, count the number of payments and store in 90_Day_Data_Count field.
   If value date minus the current date is less than 180 days but greater than 90 days count the number of payments and store in 90_{—}180_Day_Data_Count field.
(Here after Called Tally_Data_Date_{—}30_{—}90_{—}90_{—}180)
Use 30_Day_Data_Count for each Sending_Institution and array by Beneficiary to form the Sending_Instituion_By_Beneficary_{—}30_Day field.
Use 90_Day_Data_Count for each Sending_Institution and array by Beneficiary to form the Sending_Insitution_By_Beneficary_{—}90_Day field.
Use 180_Day_Data_Count for each Sending_Institution and array by Beneficiary form the Sending_Insitution_By_Beneficary_{—}180_Day field.
   As an additional or alternative display.
Use 30_Day_Data_Count for each Sending_Institution and array by intermediary institution in (56A) to form the Sending_Insitution By_Intermediary_{—}30_Day field.
Use 90_Day_Data_Count for each Sending_Institution and array by intermediary institution in (56A) to form the Sending_Insitution_By_Intermediary_{—}90_Day field.
Use 180_Day_Data_Count for each Sending_Institution and array by intermediary institution in (56A) to form the Sending_Insitution_By_Intermediary_{—}180_Day field.

Wherefore, I claim:

1. An automated electronic messaging processing method for identifying and analyzing payment related information between a user's correspondent banks, customers and competitors, and acting upon said information, said method comprising:
receiving and storing an electronic message having various fields for transporting information;
determining if beneficiary information in said message identifies the beneficiary as our customer;
if the message is related to our customer, storing the message in beneficiary queue;
analyze each stored message in said queue to identify the number of payments that could be new book transfers instead of being routed outside our banks financial network;
generating a report identifying said beneficiaries for new book transfers.

2. The automated banking method of claim 1, further including an email message serving process for the step of generating an advisory message to said correspondent bank informing said correspondent bank that said payment may be made directly from their account.

3. The automated banking method of claim 1, further including a database reporting process for step of generating an electronic report of said indirectly routed payments.

4. The automated banking method of claim 1, wherein said steps for identifying, capturing and analyzing payment information are all performed on a real-time or near-real-time basis.

5. The automated banking method of claim 1, wherein the step for capturing payment information comprises a commercially available payments solution process.

6. An automated banking method for identifying and analyzing payment related information between a user's correspondent banks, customers and competitors, and acting upon said information on a real-time or near-real-time basis, said system comprising:
means for identifying incoming payments said correspondent banks route through said competitors;
means to capture incoming payment information, wherein said incoming payment information includes the correspondent bank from which said incoming payment originated, the competitor through which said payment was sent, the correspondent bank's customer, the payment beneficiary or customer, and all payment identification information associated with said payment, said means to capture comprising a commercially available payments solution framework;
means for analyzing said incoming payment information;
means to generate an advisory message to said correspondent bank informing said correspondent bank that said payment may be made directly from their account; and
means for generating a report of said indirectly routed payments.

7. A method for identifying and analyzing payment related information between a user's correspondent banks, customers and competitors, and acting upon said information, said method comprising the steps of
identifying incoming payments said correspondent banks route through said competitors;
capturing incoming payment information, wherein said incoming payment information includes the correspondent bank from which said incoming payment originated, the competitor through which said payment was sent, the correspondent bank's customer, the payment beneficiary or customer, and all payment identification information associated with said payment;
analyzing said incoming payment information; and
reporting or displaying said analysis to said user.

8. The method of claim 7, further including the step of generating an advisory message to said correspondent bank informing said correspondent bank that said payment may be made directly from their account.

9. The method of claim 7, further including the step of generating a report of said indirectly routed payments.

10. The method of claim 7, further including the step of identifying specific customer patterns.

11. The method of claim 1 further including the step of:
identifying potential new customers or expanding a user's customer relationship to customers who have a predetermined volume of payment activity in one currency but not in another.

12. The method of claim 1 further including the step of:
identifying potential new customers who have a significant volume of payment activity from a user's existing customers.

13. The method of claim 1 further including the step of:
identifying specific patterns of conduct from a customer when analyzing data from any one of inbound on-us transfers, outbound on-us transfers, inbound not on-us transfers and outbound not on-us transfers; and
communicating an alarm to said user.
